(19) United States
(12) Patent Application Publication
(10) Pub. No.: US 2013/0151432 A1
(43) Pub. Date: Jun. 13, 2013

(54) SYSTEM, COMPUTER-STORAGE MEDIUM AND METHODS FOR ALLOCATION OF DONATIONS BETWEEN PARTIES

(71) Applicant: Gividual Solutions, Inc., Evanston, IL (US)

(72) Inventors: Megan Kashner, Evanston, IL (US); Paul Raymond Baker, Chicago, IL (US); Bilyan Belchev, Oak Park, IL (US)

(73) Assignee: Gividual Solutions, Inc., Evanston, IL (US)

(21) Appl. No.: 13/686,143

(22) Filed: Nov. 27, 2012

Related U.S. Application Data
(60) Provisional application No. 61/564,155, filed on Nov. 28, 2011.

(51) Int. Cl. G06Q 40/00

(52) U.S. Cl. 705/329

(57) ABSTRACT

A system, method, and computer-readable storage medium for allocating one or more charitable resources are disclosed for obtaining a charitable need request and validating the charitable need request by approving or denying the request based on information known about the request and the person/entity submitting the request. The charitable need request preferably is submitted by a potential beneficiary or donee to the invention, and the charitable need request preferably is validated by a local validator. Preferably, the local validator has personal knowledge of the need request and the beneficiary. Once the charitable need request is approved, one or more donors may provide time, money and/or other resources to help fulfill the need request. The donated funds and/or item(s) may be passed through the invention to the local connector acting as receiver of the funds and/or item(s) to the one or more beneficiaries. Preferably, the local connector validates the local validator.

### CROSS-REFERENCE TO RELATED APPLICATION(S)

This application is a non-provisional patent application that claims the benefit of the filing date of, and priority to, U.S. Provisional Application No. 61/564,155, filed Nov. 28, 2011, the entirety of which is incorporated herein by reference.

### FIELD OF THE INVENTION

The present invention is directed to charitable donations, and more particularly, to a system, method(s), and computer-readable storage medium to operate and/or manage allocation(s) of donation(s) between parties.

### BACKGROUND OF THE INVENTION

In the world of charities, the interaction between potential donors and their possible recipients is very limited. For example, a large pool of donors may provide items, such as money, clothes, food, etc. to one collection agency. That collection agency then allocates those donated items as it sees fit. The process is very impersonal and lacks intimacy between the donor and the donee. For example, the collection agency may designate very broad areas of interest, such as a particular problem to be solved (e.g., cancer, health disease, poverty, etc.), or geographic locations to which the items may be and/or are being provided for the sake of efficiency. However, in many instances, the donors who provided the items in the first place do not know specific details regarding their donation, such as the when, how, to whom, where, etc. Such an exchange provides a distant feeling and, in many cases, a donor may feel that the transaction lacks the human experience of a more one-to-one interaction. In various other cases, a potential donor may be deterred from making a contribution because of the lack of such donation details. Indeed, many, if not all, donors want to know the specifics and may want to directly select the recipient, a recipient's particular need for the donation, communicate directly with that recipient, etc. to enhance the human, and humane, experience and to make sure that their donation is allocated properly.

Presently, a resource through which individuals can seek support for such needs, which in some cases may be a one-time need, through a safe and validated process, does not exist. Additionally, resources are lacking for low income individuals to present their stories of striving and goals. A level two-sided marketplace for donors and those in need to interact, communicate, and help does not exist. Resources do not exist for: (i) nonprofit organizations to access the resources of a community of an individual, and (ii) institutional donors to meet the specific needs of their clients as individuals.

Moreover, various other problems exist with current donation practices. For example, advertisers have an interest in both those with specific types of needs and in those who are donors for certain types of needs. However, in instances of natural and other disasters, individual donors have balked at the practices of aggregated giving funds of existing emergency fundraising vehicles, and individuals and families lack resources to seek help directly from individuals or other parties willing to give. Employee giving programs, provided by employers to their staff, lack access to giving opportunities to meet individual needs. International giving programs targeted at matching individual giving with individual need are primarily focused on micro-lending and not outright support for those other than solely children. Opportunities for children to engage in individual contributions and group contribution projects are often not well-targeted to children as donors. The contribution of goods and services by corporations and large institutions is difficult to target to those individuals most in need of that particular need or service. There does not exist a scaled resource to meet the needs of individuals for specific goods or services. There does not exist a scaled resource to allow individual and institutional consumers of goods and services to target their contributions to a person in need of that same (or a closely related) good or service. When groups that are not 501(c) organizations seek to raise funds for a need or project, they cannot raise funds in a validated, safe way that provides a charitable deduction for their donors. Individual donors with limited giving history or net worth have poor access to dashboards and systems tailored to assist them in tracking and directing their giving. Indeed, lack of ready access to emergency funds for individuals, public misconceptions of those in need as a class, individuals who can give are seeking connection and impact, and current solutions lack validation, connection and/or scalability are some of these problems that need to be addressed. Additional problems that need to be addressed are: lack of ready access to targeted support for clients, parishioners, programs, etc.; absence of public awareness of an organization's work and impact; raising funds for individuals and groups that are not automated and not online; and current fundraising lacks online presence or any available reach is limited.

As such, there is a need in the art to handle such donation allocations between parties while providing more detailed information related to the donation. There is also a need for philanthropic platforms to conform to new norms of social networking and personal connection through electronic platforms.

In view of the above, it would be desirable to provide a system, method(s), and computer-readable storage medium that permits the allocation of one or more donations from one party to another. It would also be desirable for a third party entity acting as the go-between for the transaction to verify and validate that the donation, payment, etc. was successful.

### SUMMARY OF THE INVENTION

Tailoring the needs and individuals presented to a potential donor, according to that person's interests, geography, and/or giving history, may result in increased giving and return to the philanthropic site. Individual donors give with more frequency and at higher rates to causes associated with one singular individual and story. Donors are increasingly demanding more targeted opportunities for giving and accountability for the destination of the funds they contribute. As such, a system, method(s), and computer-readable storage medium are provided to operate and/or manage allocation(s) of donation(s) between parties. Such inventions may use software to perform the desired processes and functions (the software being referred to herein as “Gividual”). The invention provides a trustworthy platform that fuels a powerful social network while incorporating scalable validation of need and safeguards for resource flow, allowing individuals to contribute safely with true connection to those in need, and providing distinctive impact and feedback. The invention may provide: (i) financial support to individuals to prevent those individuals from backsliding into poverty; (ii) personal connection to philanthropy and impact; and/or (iii) public exposure to the stories and dynamics of lives near the edge of stability and exposure of nonprofits who directly touch and help the lives of those in need. In at least one embodiment, the operation and management focuses on the secure allocation of funds from a donor to the situation of one individual. Such management and operation includes at least: employee giving, giving to nonprofits and groups as well as to individuals, portfolio tools to track one's giving, etc. Indeed, the invention permits users to highlight and raise funds for individuals, projects, and groups within an organization or congregation in an online, trusted, secure and accessible environment in which user constituents and members can post and update needs and a donor network can extend past its current boundaries.

Gividual provides a secure and validated online support to allow individuals to seek support for one-time need through a crowd-funding model from other individuals. This validation is unique and involves intermediary nonprofit organizations as validators and grantees. Gividual provides nonprofits with access to individual donors to meet the financial needs of the nonprofit's clients in one of two ways—through one of Gividual's nonprofit licensees, such as Benevolent.net, or through direct licensure of the software for the specific use of the nonprofit to showcase and raise funds for the needs of their own clients and constituents. Gividual provides a platform for the presentation of individual needs through narrative, video and photographic presentation. Giving opportunities are directed to and linked to individual needs presented.

Gividual's platform does not aggregate giving into general funds, but rather keeps donor directives clear and segregated according to the need(s) that donor has selected to support. Gividual provides the software necessary to create this platform and to replicate it across a variety of nonprofit organizations and associations.

Gividual provides the tools for both the donor, the person in need and the nonprofit associated with that person to present and tailor their content and interaction with the site using the software.

Gividual may use and create methods of communication, interaction, following, preferences, and interface resonant of current and future social networking platforms and interfaces. These functions may allow connection between those in need, donors, and nonprofit professionals to interact and tailor their experiences and communication to suit their needs and interests. Gividual's software may support and promote sorting, searching and prioritizing content for the user. Gividual may create special interfaces to allow fast disaster response activation on the part of nonprofit users of the software in order to allow those with disaster-related needs to seek support quickly and securely and those nonprofits who know and work with disaster-impacted individuals to use the Gividual software to quickly seek help for and validate the needs of their clients. Gividual software may allow donors to give to meet directly the needs of those impacted by disaster and validated by the nonprofit with whom they are affiliated. Gividual may create employee giving interfaces which operate to be able to be tailored to corporate need and wishes in creating platforms for employee giving. Gividual may scale to work outside the US and to create giving processes suited to other countries and international giving.

Gividual may operate to provide a tailored solution to present giving opportunities to children, under the supervision of their parents, in a safe, vetted, edited and monitored manner. Gividual may meet this need by tailoring solutions to corporations and large institutions seeking to target their giving of goods and services to those most in need. Individuals with needs for goods and/or services may be able to use the Gividual software and platform to seek that which they need. Gividual may create solutions to allow providers and/or donors of goods and services to target their goods or services to those in need of that good or service with consideration of security, geography, fulfillment and logistics. Gividual may craft software and online solutions tailored to the needs of groups to raise funds for specific needs. Gividual may allow advertising to target those individuals with needs and those nonprofits and donors most of interest. Gividual may expand its platform to allow donations to individuals, groups and nonprofits and may craft tailored solutions to provide donor dashboards and portfolio tools to track, target, and manage giving both at one time and over a period of time in a planned and advised giving manner.

Benevolent.net is a robust platform for modern personal philanthropy and provides great support of the benefactor/donor and beneficiary experiences in a format blending the accountability and broad market access of an investment account with the individualization of a social networking experience. Benvolent.net utilizes the Gividual platform invention.

### Concept:

Benevolent.net is to be an online community in which individuals and groups can register their needs—big or small—in the hopes of finding benefactor(s) to support that need. Conversely, individuals may find an experience at Benevolent.net which allows them to browse and search a robust market of philanthropic options for giving in an online environment which acts in some ways like a banking account and in others like a comfortable social network. The platform may allow direct support by community members for causes they select themselves and to which their support flows directly and may provide dashboards, alerts, and giving options according to the user's preferences. By connecting ourselves directly to those who express their needs and the backstory and expected outcomes of the fulfillment of those needs—be it a parent's need for money to repair the car essential to transport to and from work, or a community center's desire to start a community garden in its most impoverished neighborhood—Benevolent.net may provide us with the opportunity to reconnect to our best selves and follow our own paths in living out our values and beliefs. The Benevolent.net platform may combine: (i) the simplicity of a registry to communicate need and track progress towards meeting that goal; (ii) a validation and recommendation concept to provide secure and trustworthy transactions; (iii) a personal connection to individualize the connection including photos, video, narrative, and messaging; (iv) simplicity of search criteria and security of transactions; (v) the streamlined ability to channel support directly from your household to those in need; (vi) the clarity of dashboard and account detail displays to reflect giving history and impact; (vii) the support of advanced philanthropic portfolio tools to help guide those wishing to give in determining their philanthropic choices; and (viii) the support of a donor advised or investment fund with regard to taxability, deductions, and the secure flow of funds.

The Donor Experience: (i) create a Benevolent profile; (ii) accumulate funds for giving through payroll deductions, regular transfers, credit card transactions or gifts; (iii) engage in giving at contribution levels you can afford and in a manner consistent with your beliefs and experience without having to establish a family foundation, donor advised fund, or other philanthropic vehicle; (iv) search for individuals or groups you'd like to support with intuitive search inputs; (v) access narratives and videos about need and back story; (vi) fulfill stated needs in part or in full or create a portfolio of directed giving according to your wishes; (vii) send a personal message to accompany your gift; invite a response if you choose; (viii) spread the word to your network via Facebook, LinkedIn, Twitter, and more; (ix) follow your giving and manage your connection to issues you care about directly and with full control and perspective; (x) engage in Benevolent.com as an individual, employee, group member, or through a related partner experience; (xi) personalize the experience and interface to your outlook and preferences for information and contact; and (xii) track your giving and its impact on your own dashboard of giving and receive simple reporting including clear documentation for income tax reporting and other filings.

The Beneficiary Experience: (i) create a Benevolent Profile; (ii) check out what others have posted and what seems to work; (iii) determine whether your need, or some part of your need, would be well-met through this platform; (iv) register your need by filling in fields and checking boxes to describe your situation and your need; (v) communicate your plan for how the fulfillment of this need may help you move your life forward in a significant way; (vi) inform your readers and the Benevolent community of your plans to become a benefactor in the future; (vii) complete the registration of your need with a narrative and any photos, links or videos you think may help benefactors know your situation and your need well; (viii) select from timeline options for your need fulfillment and expiration; (ix) invite your community to view your registered need of you feel comfortable with that exposure; (x) monitor your need fulfillment through your chosen alert profile; (xi) receive the funds to meet your need through secure transactions; (xii) receive secure messages (if invited) from benefactors; (xiii) thank your benefactors through the secure message system; (xiv) return to update your community on your outcomes and progress; (xv) return up to four times over four years to register your needs; and (xvi) return as a benefactor to pay forward the support you received and help someone in need of a hand up.

The Nonprofit or Group Experience: (i) establish a Benevolent Account; (ii) check out what others have posted and what seems to work; (iii) determine whether your group's needs would be well-met through this platform; (iv) register up to four needs (general operating support, a targeted campaign, funding for specific programs) by filling in fields and checking boxes to describe your situation and your need; (v) communicate your plan for how the fulfillment of this need may move your organization forward in delivering on your mission; (vi) complete the registration of your need with a narrative and any photos, links or videos you think may help benefactors know your mission, programs and needs well; (vii) select from timeline options for campaign completion and milestones and flow of funds; (viii) invite your community to view your registered needs; (ix) monitor your need fulfillment through your chosen alert profiles; (x) receive the funds to meet your need through electronic fund transfers; (xi) receive secure messages from benefactors; (xii) thank your benefactors through the secure message system; and (xiii) return to complete timely updating of outcomes and performance.

The Corporate Experience: (i) establish a Benevolent Account and corporate preferences and appearance for the interface; (ii) establish access for employees to direct their giving and employee match, and/or; (iii) establish campaigns and preference settings for corporate units to engage in group giving, and/or; (iv) establish a broad-based campaign to fulfill needs in one or more focused areas of philanthropic interest, and/or; (v) establish profiles to allow employees or units to accumulate funds through payroll deductions to create a leveraged portfolio of directed giving according to their wishes; (vi) send a personal message to accompany each gift, clearly identifying your corporation as the benefactor or employer-sponsor of the giving if you wish; (vii) spread the word across your marketing platforms and in internal communications; and (viii) track your giving and its impact on employee-, group- and corporate-level dashboards of giving and receive simple reporting.

The Retail Experience: (i) establish a partnership with Benevolent in one or more of your online retail outlets; (ii) allow Benevolent.com members to register their needs for your retail items (similar to a gift registry), linking to the narrative and Benevolent profile information on Benevolent.com; (iii) prompt your customers (all or a customer segment) to contribute to the fulfillment of the needs of Benevolent.com beneficiaries with needs similar to their purchased items; (iv) fulfill the registry needs of beneficiaries (individual, group or nonprofit) directly through your fulfillment systems; (v) contribute corporate resources to the campaign through free shipping, partnership development and system support, and/or optional matching funds to match your shoppers' donations; and (vi) track your giving and impact on customer-, segment- and company level dashboards of giving and receive simple reporting.

### Need:

Everyone needs a hand at some point. Some of us have had the benefit of parents purchasing our textbooks or paying some of our tuition, many of us have had help from our church or our community, some have taken advantage of a network of friends for a place to live, a car to borrow, or twenty dollars until payday. For our nation's working and struggling poor and for those experiencing crises and opportunities, however, those significant hands up are often out of reach. Because so many of our social and political systems are designed out of mistrust, it is incumbent upon those of us who believe in the promise and integrity of individuals and families to act on our beliefs.

### Individual and Family Need

Emergency funds to help individuals and families out of a bind or to take advantage of a window of opportunity are fading into distant memory. Public welfare, workforce development, and even food support systems are predicated on the belief that if we put money in the hands of those who are living at risk and in poverty, they may make the wrong decisions. They allegedly may certainly purchase cheese puffs and a Gucci knockoff rather than applying any funds received to education, nutrition, or a safety deposit for rent. While our systems of governmental, philanthropic and nonprofit support are essential and largely well directed, we have, as a society, lost our trust in one another and in the ability for an individual or family to set their own course and follow it to greater stability, health, and success.

### Group or Organizational Need

When groups that are not 501(c) organizations seek to raise funds for a need or project, they cannot raise funds in a validated, safe way that provides a charitable deduction for their donors. For example, a school group may want to raise funds for a community service project, a scout troop may want to raise money for an educational opportunity or a religious group may need to funding to support their outreach work. These groups may use the Gividual platform through Benevolent.net or another interface to find and facilitate donors who want to help their efforts.

### The Need to be Benevolent

Today, our networks of connection and belief have woven across the country across the boundaries of cities, religion and political bent. More than at any time in our history, we are connected to one another. More than any time in history, we are miles apart and alone. More than any time since the great depression, those in need and those at risk have to wait, jump through hoops and prove themselves not only worthy, but patient and acquiescent in order to receive a hand up and out.

The Need to be Benevolent:

Today, our networks of connection and belief have woven across the country across the boundaries of cities, religion and political bent. More than any time in our history, we are connected to one another. More than any time in history, we are miles apart and alone. More than any time since the great depression, those in need and those at risk have to wait, jump through hoops and prove themselves not only worthy, but patient and acquiescent in order to receive a hand up and out. The internet has revolutionized our connections to one another, but has yet to effectively build the connections between individuals who believe in change and in the power of helping others to those in need and seeking out support. Our nonprofit sector has no centralized platform to reach those who would seek them out and no third party entities to make the search, selection, and payment to individuals and organizations with worthy needs and goals secure and supported. Benevolent.net aims to meet that challenge, connect people with one another, with their communities, and with themselves.

Business Environment:

Today's generous individuals, corporations and groups have several options for contributing to the stability and success of those in need and at risk. Some of these include giving directly to nonprofit organizations, giving to consolidated campaigns who re-gift some portion of the contributions collected to nonprofits in their community, the establishment of a family foundation or donor advised fund, and more. There are several challenges to this system which result in unnecessary shaving off of charitable dollars before their impact reaches its way to those in need of the intended help. Additional challenges remove us further and further from the need for and use of our gift in terms of a feeling of connection and complete information and access. Giving to the United Way, for example, often results in 15% to 25% of all contributions going to pay for salaries and expenses for the United Way's operations. Because the United Way does not deliver direct services to the community, this means that only about 800 on every donated dollar is flowing through to a nonprofit organization in that United Way's community. Then, when that 800 reaches the nonprofit organization, another 8% to 20% is expended (generally out of necessity) on fundraising and administration to keep that nonprofit afloat and delivering services. What this means, however, is that when it comes to direct support and resources handed from a donor to a needy recipient, only about 700 makes it through. This is a highly inefficient system and presumes that generous donors need to pay the equivalent of up to 30% of their gift amount just to support the solicitation and processing of their gift.

### CONCLUSION AND SUMMARY OF NEED

### Design:

The invention provides a membership-based community in which members can be benefactors and/or registrants of need at any point in the course of their membership. Membership may be free and may require a personal profile. One's profile can be more or less complete, depending on the investment of time and trust of the user, but in order to register a need, one's profile may be required to be complete. Photos and images may be used to personalize contact and experience of one another. The invention provides a platform for photo sharing and profile photos. Recommendations may be used by nonprofits, schools, churches and others to endorse Beneficiaries and their needs (e.g., like a financial aid office endorsing a student's need for money for furnishings or books, or a social service agency endorsing a family's need for car repairs).

Individuals may register their needs for money or items. To register a need one may be required to state: (i) the reason for the need; (ii) the complete need (this may require some standardized fields to be completed to ease benefactors' searches for needs within their interest areas as well as a narrative of the need); (iii) the expected benefit of having the need met; (iv) the expected long-term impact of having the need met on the individual or his/her family; and (v) the registrant's plan to become a benefactor. Benefactors may visit the site and may have access to search for needs according to categories, geography, size of the need, sub-groups like veterans, lgbt, teen moms, etc. Once the benefactor identifies a need he/she would like to help fulfill (note that one benefactor can partially fulfill a need and then encourage others in his or her network to join in and complete the fulfillment of that need), he or she identifies the amount and payment preferences and completes the transaction. The possibilities of connection to commonalities and community is strong during stage one—benefactors supporting families in need at their child's school, benefactors experiencing cancer supporting others with the same illness but fewer means.

In addition to direct contributions from benefactors/donors to beneficiaries, a portion of any and all revenues of the central organization (whether for or not for profit) may be reserved for the Benevolent Foundation which may fulfill its own volume of need requests in order to balance out inequities in benefactor choice during this initial stage and to allow direct philanthropy on the part of the founder and board of Benevolent.org. Those registering need and communities may receive suggestions as to ways to promote their need and spur interest in their own communities.

Aspects of the vetting and certification of need process of such a stage may be developed into automated processes. Development of case studies, video testimonials, and more may be used to enhance the community experience.

The invention may be used locally, nationally or internationally.

Partnerships may be possible with vendors, such as Amazon, Target, etc. so that people can register for items more easily. Moreover, partnerships with nonprofits may allow those nonprofits to register their needs and to register the needs of their clients.

Facebook, IPod and Android apps may be used with the invention. Member dashboards or news feeds may reflect their giving and its impact upon login.

Retailers may encourage customers who have bought an item to buy a duplicate of that same item for someone who has registered a need for that item or that class of item.

Classrooms may be provided such that members may register as benefactors and become pen pals with a classroom from a community with greater need.

The invention may act as a philanthropic platform in which benefactors can give to individuals or nonprofits through direct choice and investigation or can set priorities for a balanced philanthropic portfolio whose giving reflects his or her wishes. The invention allows direct support by community members for causes and needs they select themselves and to which their support flows directly. Needs are marked by their clarity and direct impact—not distant and theoretical, but direct and demonstrable. The solution of this invention fits directly into the current schema of scalable impact while at the same time stepping away from the notion that solutions are not to be found at the individual level—only at the community or societal level. The invention provides a platform to facilitate just that—individuals causing good for distinct individuals facing challenges. The platform may, in facilitating giving from individual to individual, facilitated through a trusted community nonprofit, also encourage giving to those organizations who are most closely in touch with those in need. Upon selecting an individual to help, the giver may additionally be given the opportunity to support the nonprofit organization which is acting as that person's payee, thereby funneling support not only to individuals with a need for transformative support as well as to those organizations on the ground in the community who are making a difference in the lives of real people facing real challenges every day. The invention may be implemented via a website with access possible on mobile devices and to giving through text.

### BRIEF DESCRIPTION OF THE DRAWINGS

For the purposes of illustrating the various aspects of the invention, wherein like numerals indicate like elements, there are shown in the drawings simplified forms that may be employed, it being understood, however, that the invention is not limited by or to the precise arrangements and instrumentalities shown. To assist those of ordinary skill in the relevant art in making and using the subject matter hereof, reference is made to the appended drawings and figures, wherein:

FIG. 1 is a flow diagram showing a process overview for need Identification and Fulfillment in accordance with one or more aspects of the present invention;

FIG. 2 is a flow diagram showing at least one scenario for usage of the present invention by one or more DONOR(S) to identify a need and fulfill same in accordance with one or more aspects of the present invention;

FIG. 3 is a flow diagram showing at least one donor experience “before” and “after” using the present invention in accordance with one or more aspects of the present invention;

FIG. 4 is a diagram showing one or more roles and relationships of donor(s) and recipient(s) with Benevolent employing the present invention facilitating the exchange(s) between the donor(s) and the recipient(s) in accordance with one or more aspects of the present invention;

FIG. 5 is a flow chart showing one or more relationship(s) of the functional roles of the invention for allocating one or more donations to one or more needs in accordance with one or more aspects of the present invention;

FIG. 6 is a diagram providing an overview of the functionality of at least one platform in accordance with one or more aspects of the present invention;

FIG. 7 is an example of at least one embodiment of a platform of the present invention for corporate giving in accordance with one or more aspects of the present invention;

FIG. 8 is a screenshot visual representation of at least one individual recipient's need profile in accordance with one or more aspects of the present invention;

FIG. 9 is a sample webpage for a recipient having a personal video of that recipient explaining her need in accordance with one or more aspects of the present invention;

FIG. 10 is a visual representation of at least one embodiment of a homepage being used for need research and selection of a platform in accordance with one or more aspects of the present invention;

FIG. 11 is a screenshot of a sample of a data entry process for a recipient and his or her need in at least one embodiment of the platform in accordance with one or more aspects of the present invention;

FIG. 12 is a screenshot visual representation for a screen where additional data is entered in at least one data entry process embodiment for a recipient's need in accordance with one or more aspects of the present invention;

FIG. 13 is a screenshot visual representation for a screen where data is entered in at least one data entry process embodiment to validate a recipient's need in accordance with one or more aspects of the present invention;

FIG. 14 is a screenshot visual representation of at least one embodiment for a screen where information is displayed for a validator of one or more recipient's need with a list of needs validated by the validator in accordance with one or more aspects of the present invention;

FIG. 15 is a screenshot visual representation of at least one embodiment for a screen where information is displayed showing one or more need community updates and one or more need funding statuses for one or more recipient's need(s) in accordance with one or more aspects of the present invention;

FIG. 16 is a diagram providing an overview of at least one fund flow process and functionality thereof for funding from one or more donors to one or more recipients, including one or more sample process expenses, in accordance with one or more aspects of the present invention;

FIG. 17 is a screenshot visual representation of at least one embodiment for a screen where a donor may provide support and/or information for one or more recipient's need(s) in accordance with one or more aspects of the present invention;

FIG. 18 is a screenshot visual representation of at least one embodiment for a screen where a donor may use one or more community links to share their support through one or more social media options and/or through other electronic means of communication in accordance with one or more aspects of the present invention;

FIG. 19 is a schematic of at least one system having one or more data storage media, one or more computer processors and one or more communications links for storing and running the platform software in accordance with one or more aspects of the present invention;

FIG. 20 is a screenshot visual representation of at least one embodiment for a user interface screen where an individual or organization may join the user network in accordance with one or more aspects of the present invention;

FIG. 21 is a screenshot visual representation of at least one embodiment for a user interface screen where an individual or organization may enter data or information for a potential local connector in accordance with one or more aspects of the present invention;

FIG. 22 is a screenshot visual representation of at least one embodiment for a user interface screen where an individual or organization may enter data or information for local connector organization(s) in accordance with one or more aspects of the present invention;

FIG. 23 is a screenshot visual representation of at least one embodiment for a screen where information is displayed showing information for a local connector in accordance with one or more aspects of the present invention;

FIG. 24 is a screenshot visual representation of at least one embodiment for a campaign homepage in accordance with one or more aspects of the present invention;

FIG. 25 is a screenshot visual representation of at least one embodiment for gift or need wish list page in accordance with one or more aspects of the present invention;

FIG. 26 is a screenshot visual representation of at least one embodiment for hyper-local brand integration into a webpage in accordance with one or more aspects of the present invention; and

FIG. 27 is a screenshot visual representation of at least one embodiment for a portable need or campaign content placement in accordance with one or more aspects of the present invention.

### DETAILED DESCRIPTION OF THE PRESENT INVENTION

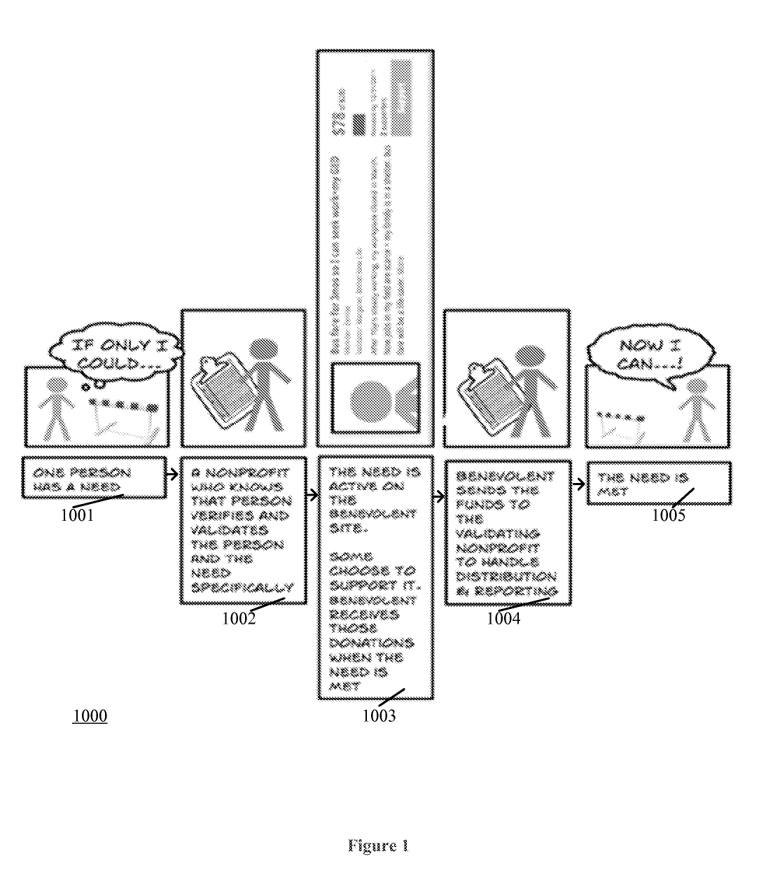

A system, method(s), and computer-readable storage medium are provided to operate and/or manage allocation(s) of donation(s) between parties. In general, the invention provides a unique way to allow one party to donate to another party's charitable need through a third party entity, which acts to make sure the donation is secure and validated. Several embodiments of the methods, which may be carried out by the, system and computer-readable storage medium of the invention are described visually in FIGS. 1 through 4.

FIG. 1 gives an overview of a process 1000 by which an individual identifies that they have a need (step 1001), affiliate with and get validation for their need by a nonprofit entity (step 1002), posts the validated need on one or more websites (step 1003), such as, but not limited to, the Benevolent site, using one or more platforms of the present invention, such as, but not limited to, the Gividual platform. FIG. 1 also describes how the Beneficiary's “need” may receive one or more donations from those who wish to help (see step 1003), as well as how the funds are sent to the validating nonprofit organization to handle distribution and reporting for the funded need (step 1004). Finally, the need is met once the person or entity receives the funds (step 1005).

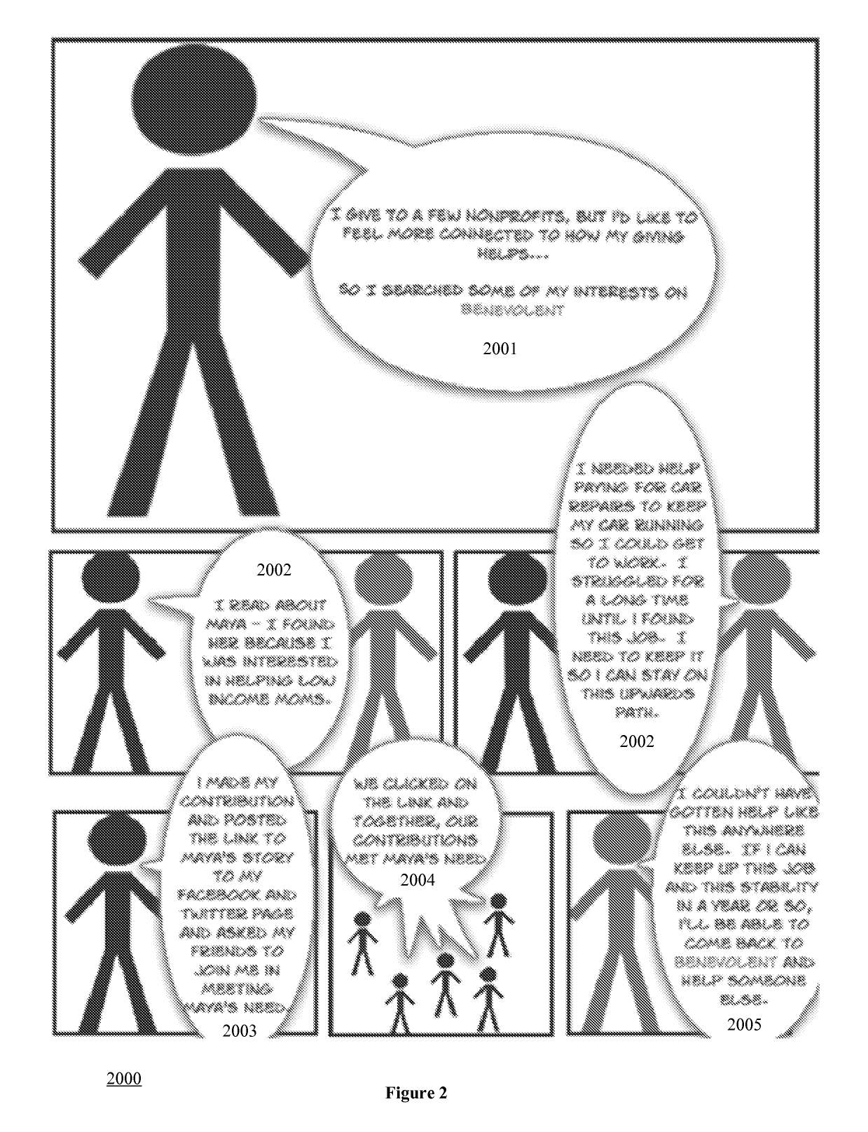

As best seen in FIG. 2, one or more donors may employ a search and decision process 2000 to determine how to allocate their funds. Donors, who need assistance in determining how to assign their designated philanthropic funds, may use the present invention to research, choose and donate. For example, the donors may search their interests on the platform (step 2001). Additionally or alternatively, one or more donors may read about a particular, single need (step 2002). Additionally or alternatively, donors may make a tribute gift or donation in the name of a loved one or colleague. Once the gift or donation is made, an email may be sent to the person chosen to be named for the tribute gift or donation. A singular need may be advertised by a donor (step 2003) so that the need may be met by multiple donors (see e.g., step 2004) if needed. Additionally or alternatively, an individual donor may support multiple needs. The funds are then transferred to the recipient, and the recipient may post feedback as to how the funds have helped (step 2005).

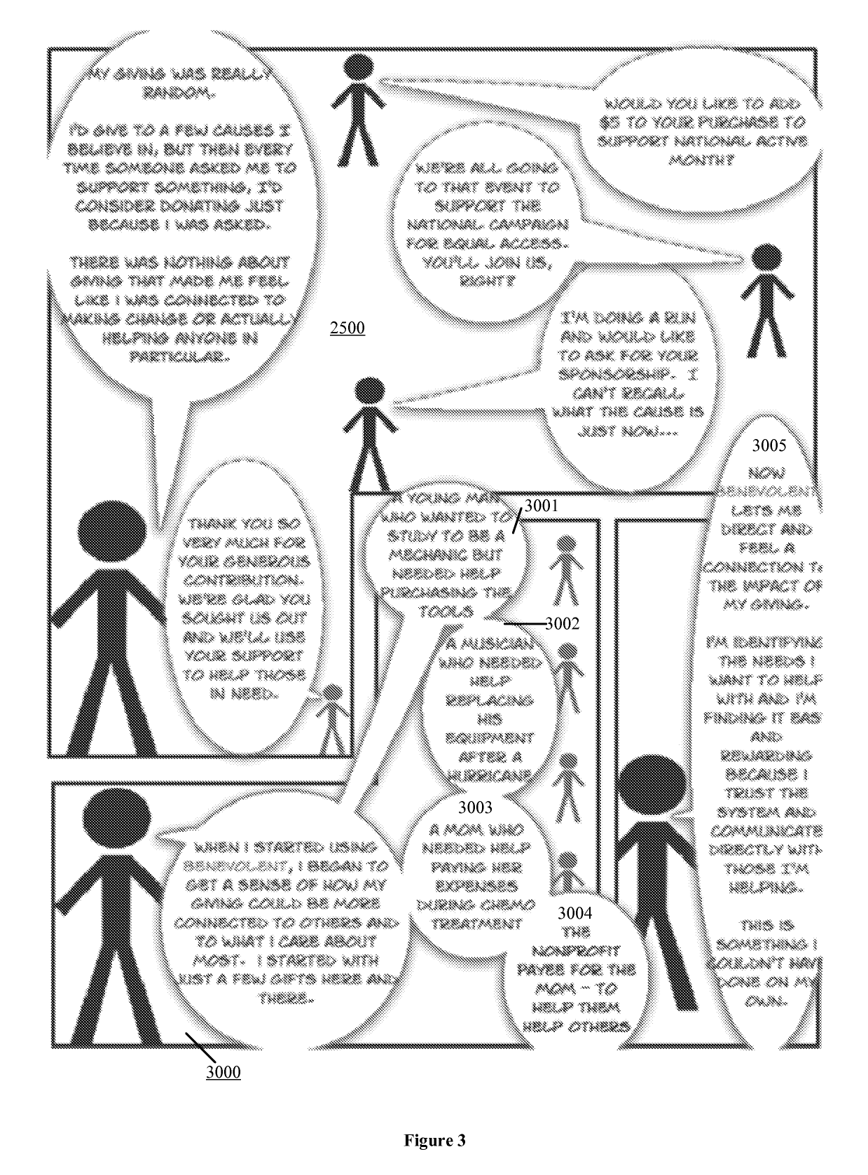

The “before” (i.e., before using the present invention) and “after” (i.e., after or during use of the present invention) donor experiences relative to making giving decisions, connecting and communicating directly with recipients making a secure, validated donation is described in FIG. 3. For instance, the “before” process 2500 typically involved a donor donating to a few causes without any real connection to the recipients or charitable events/causes. At least one embodiment of the “after” process 3000 may involve one or more donors getting a sense of connection to the recipients and needs thereof by identifying one or more needs (e.g., see steps 3001-3004) and by feeling that connection directly since the donor can not only identify the needs that the donor connects to, but the donor can also trust the process and/or system permitting the transfer of funds and communicate directly with the recipient(s) (step 3005).

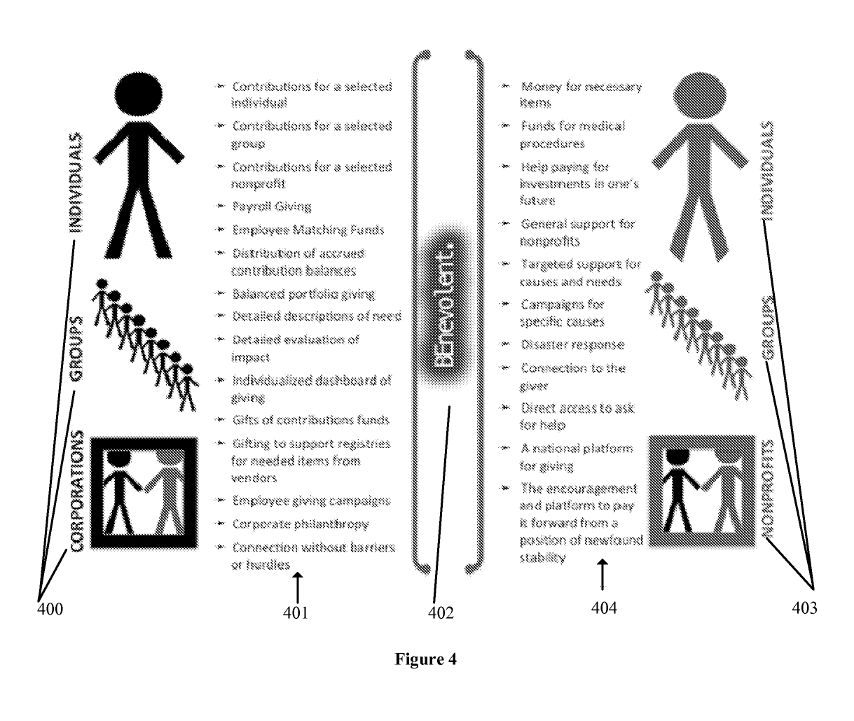

The parties and their respective charitable needs may include multiple roles (e.g., donor roles 401 and recipient roles 404) and relationships (e.g., donors 400 and recipients 403). These roles 401, 404 are shown in FIG. 4, where donors 400 are shown on the left, the third party entity 402 facilitating the donation is shown in the middle (e.g., Benevolent.net) and donees or recipients (403) are shown on the right.

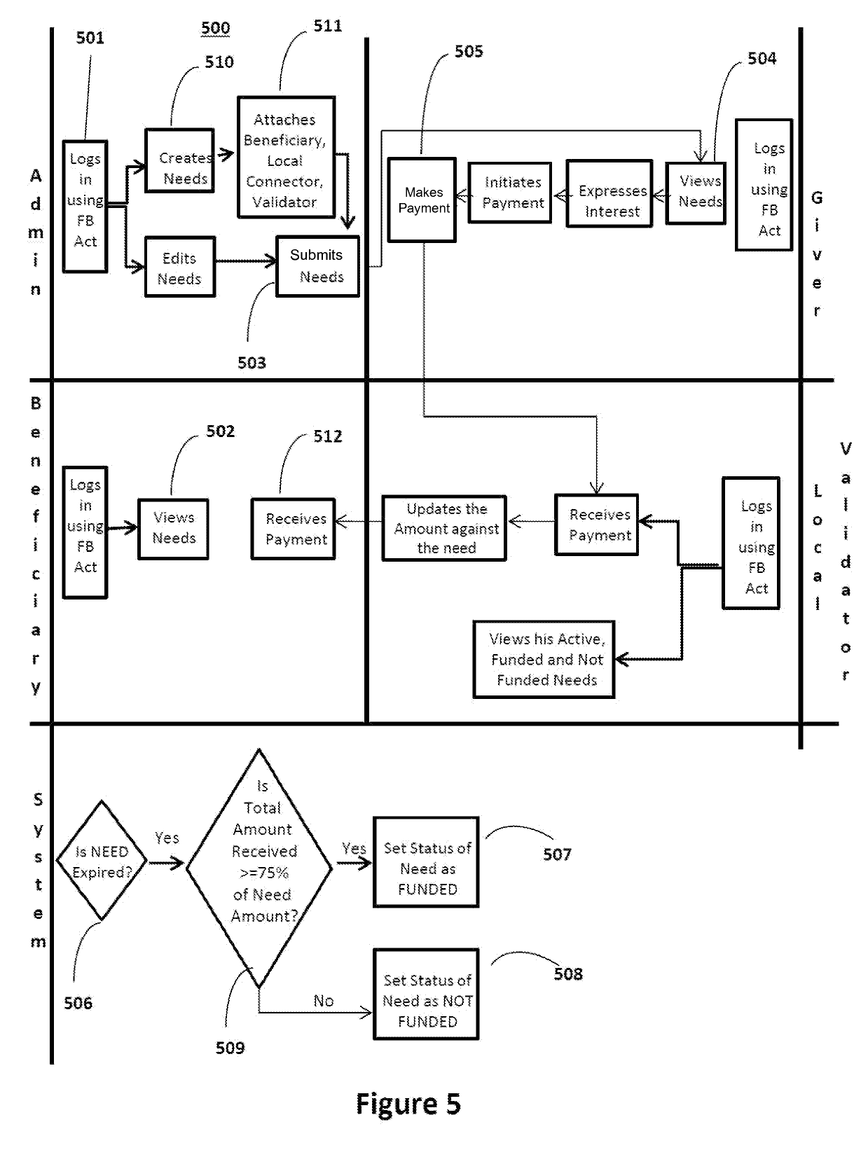

The method for allocating one or more donations between parties may include multiple actions. These actions may include Account Member creation, Local Connector identification, creation and authentication, Local Validator authentication, “Need” (also referred to as a “NEED”) creation, “Need” validation and “Need” funding. There are also various actions related to creating “Need” searches, “Need” communities and member connections. Each of these actions may include several process steps (see e.g., at least FIGS. 5-11).

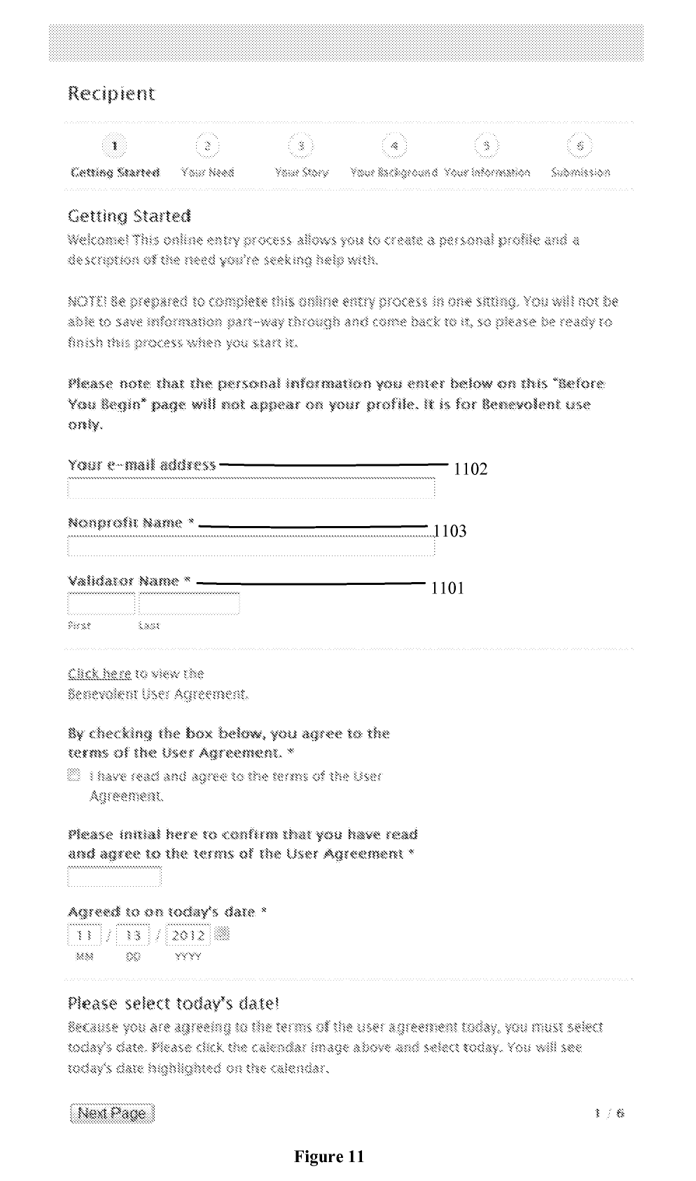

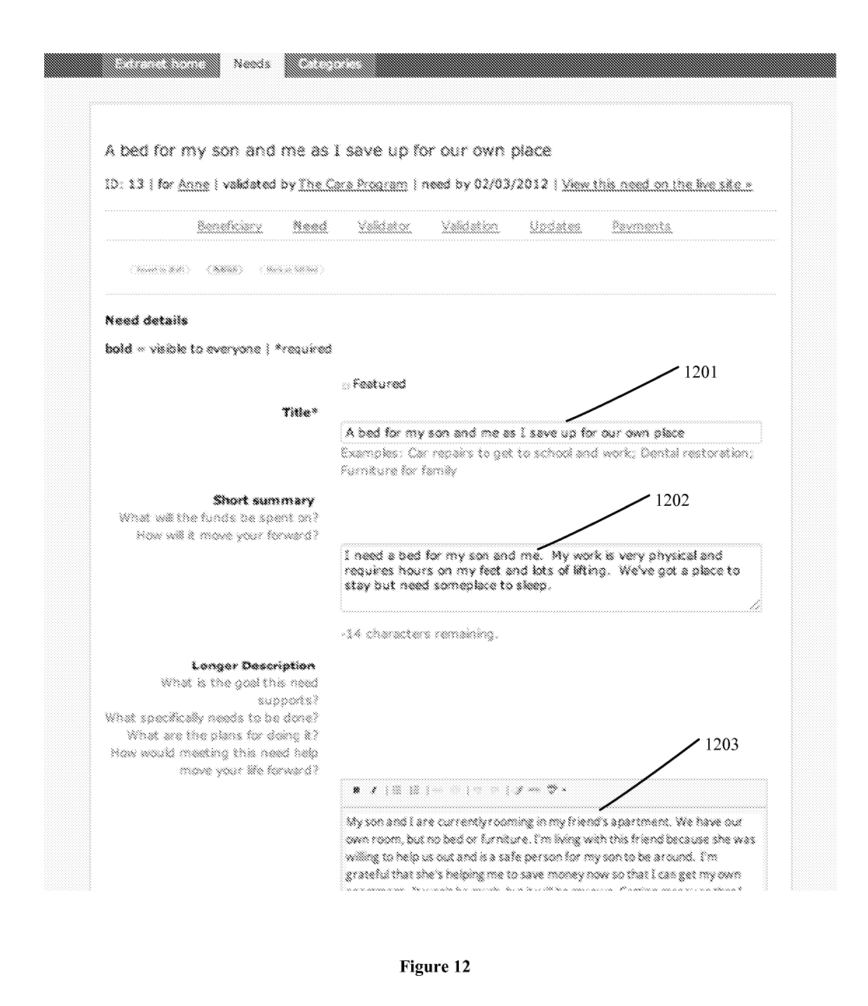

In at least one embodiment of the invention, there may be several process steps involved in creating a member account at Benevolent. First, at Benevolent.net, one preferably clicks on the option to create a new Benevolent ID or Login via Facebook (“FB”) ID (see e.g., step 502 in FIG. 5 or see FIG. 11). Other login ID's may be designed and employed. ID creation may be protected from SPAM using a random word generator. Password strength may also be determined to protect the user's password. One or more accounts may be limited to one account per member, and information may be cross-checked to that end. A member may input areas of interest to affect one or more news feeds and/or one or more search results such as, but not limited to, geography, need type(s), etc. It is also possible for a member to create a login at Benevolent.net through a social networking site, such as Facebook. After creating a Member account, the Member may answer questions about themselves that will be used to create a Member profile and/or provide personal circumstances relative to a “need” the individual may have (see e.g., FIG. 12). Questions that may be asked as part of the aforementioned method for gathering Member data may include one or more of the following:
1. Please tell us your age.
2. Are you male or female?
3. How many people are living in your household?
4. Please list the ages of any family/non-family members (if applicable) for whom you are responsible (who depend on you for support—food, shelter, day-to-day assistance).
5. How long have you lived in your current residence?
6. Do you own or rent your home/apartment?
7. What is your current employment situation?
8. If you are currently employed, please tell us about your current work situation and help us understand how you managed to get this job (through a friend/acquaintance, by answering an ad, etc). If you are currently unemployed, please let us know if you have been actively looking for employment over the past year, and what sort of job opportunities you have sought?
9. If you were ever employed previously, please tell us about your prior employer and the circumstances surrounding your departure from this/these jobs.
10. Please tell us how long you attended school and whether you were able to progress as far as you had hoped? If not, please share what you can about the circumstances that caused you to leave school.
11. Have you ever been assisted by any community organizations or agencies over the past few years?
12. If you answered yes to question 10, what type of assistance were you able to get from this/these organization(s)? If you answered no to question 10, please explain whether you have tried to get assistance but were not able to, or whether you have never felt the need or desire to seek help in this way.
13. How would you describe the current situation for which you are seeking assistance?Please provide as much detail as possible.
14. What do you imagine might happen if you are unable to find a solution to the challenge you described in question 13 above?
15. If you are able to get the help you are seeking for the problem you identified in question 13, how would this affect your current situation? What would change if you were able to find a solution to this problem?
16. Do you have specific ideas as to what specifically you might do to address this challenge?What does a “solution” look like?
17. How can Benevolent.net provide an immediate solution to your current situation?
18. Is there more than one solution to this problem, or is there a piece of this problem that must urgently be remedied to prevent the situation from immediately getting worse?
19. If Benevolent.net were able to address this problem at this time, do you envision it as a one-time issue or is it likely to recur in the near future?

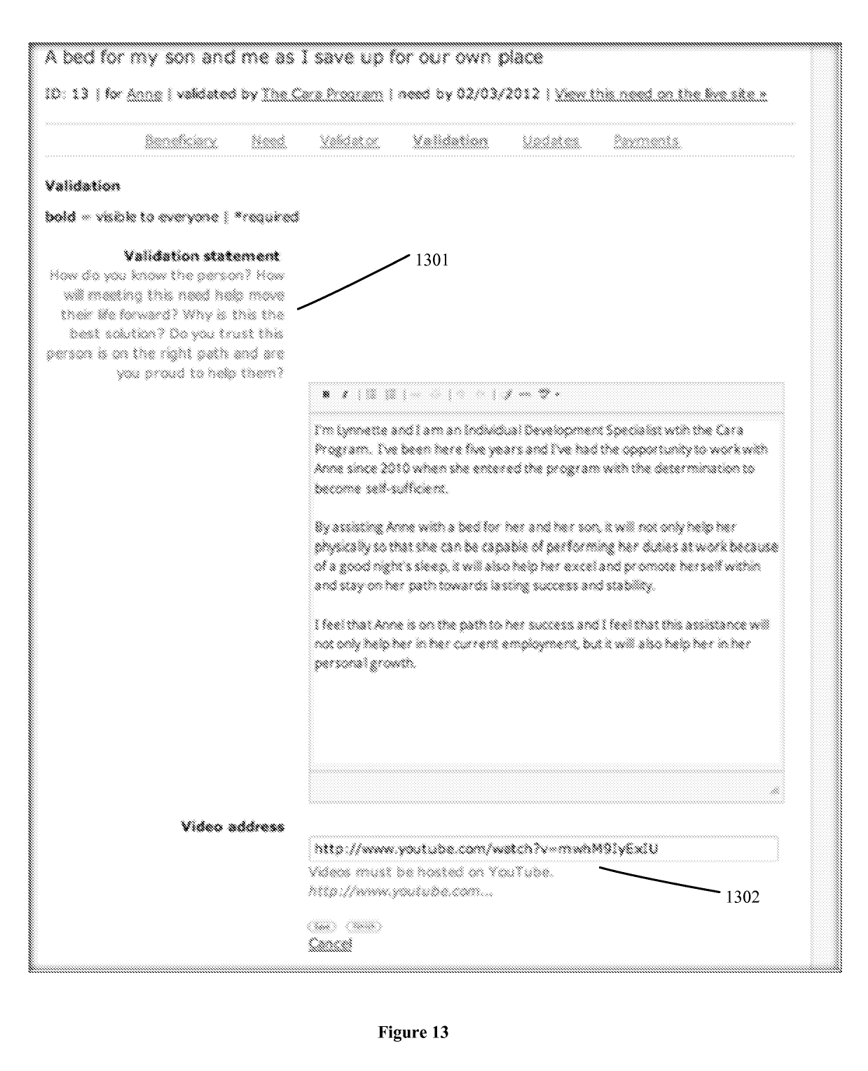

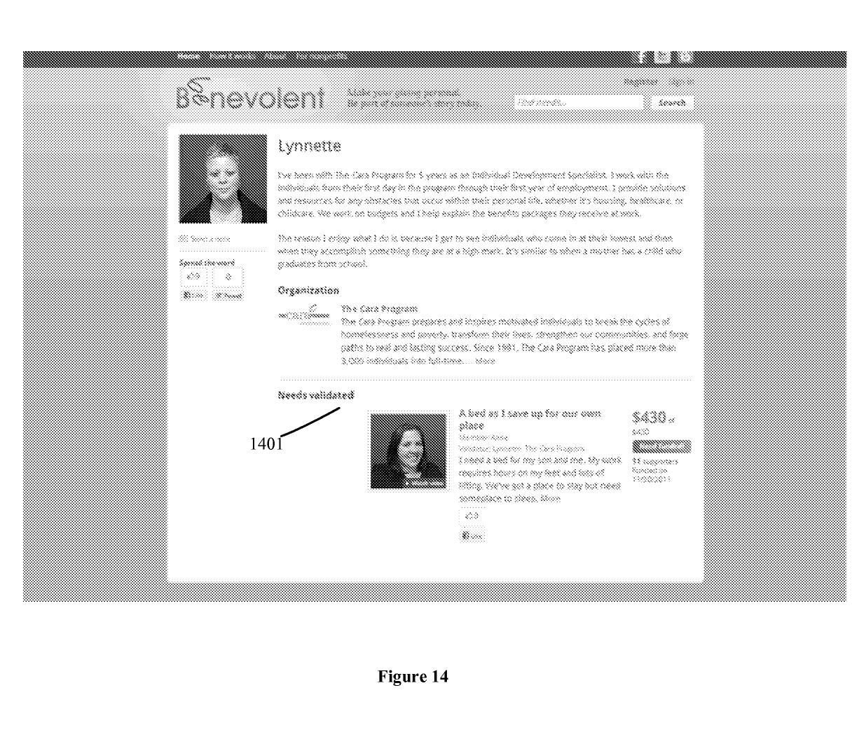

Members who wish to become Local Validators for an organization have steps involved in authenticating their organization (best seen in FIG. 13). Once a member is approved as a Local Validator, a webpage profile for the Local Validator may be displayed online (best seen in FIG. 14).

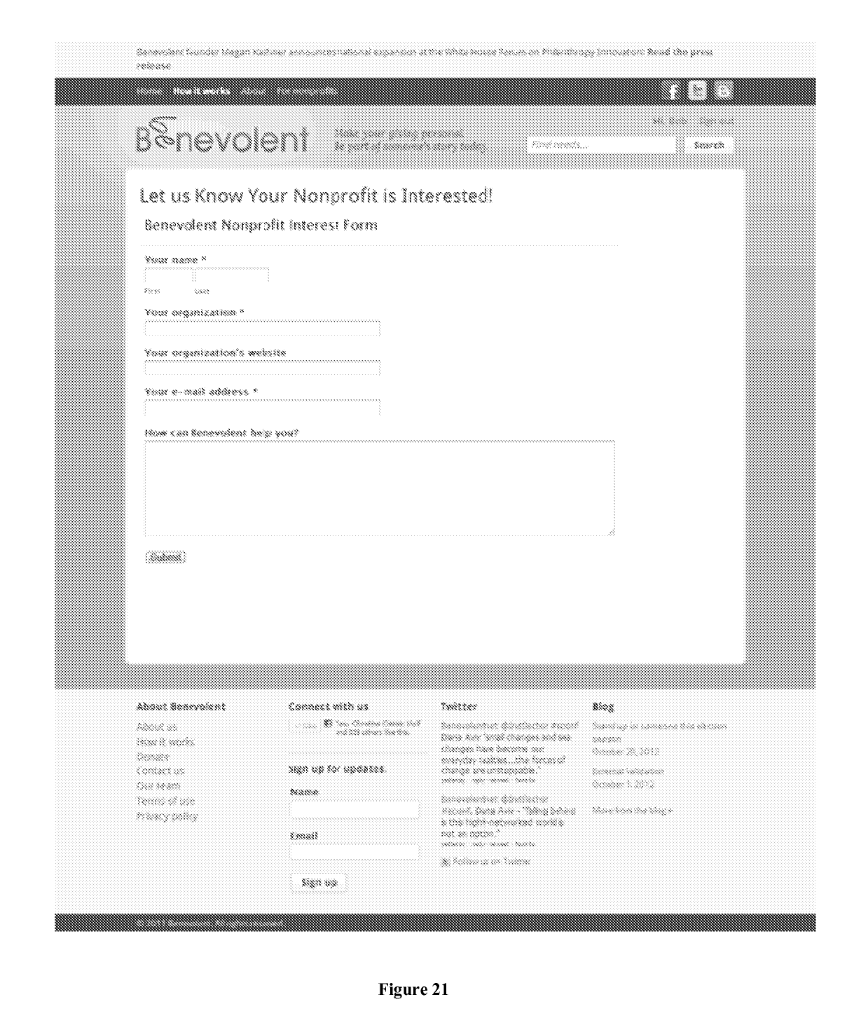

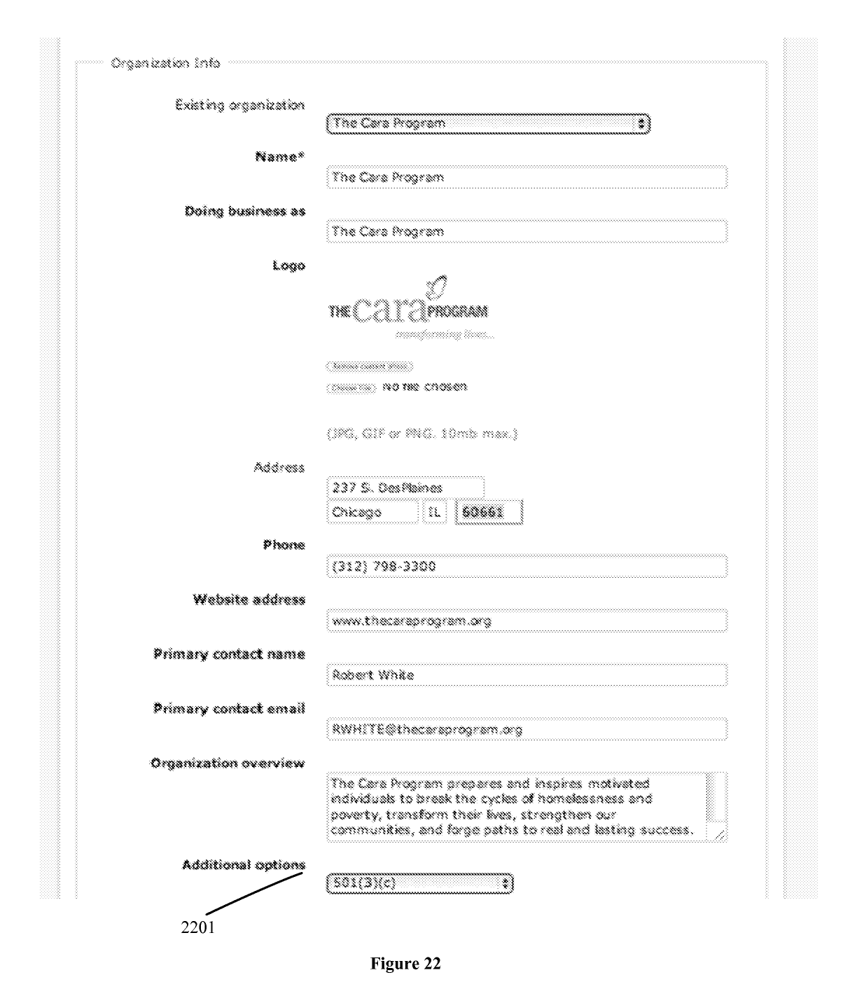

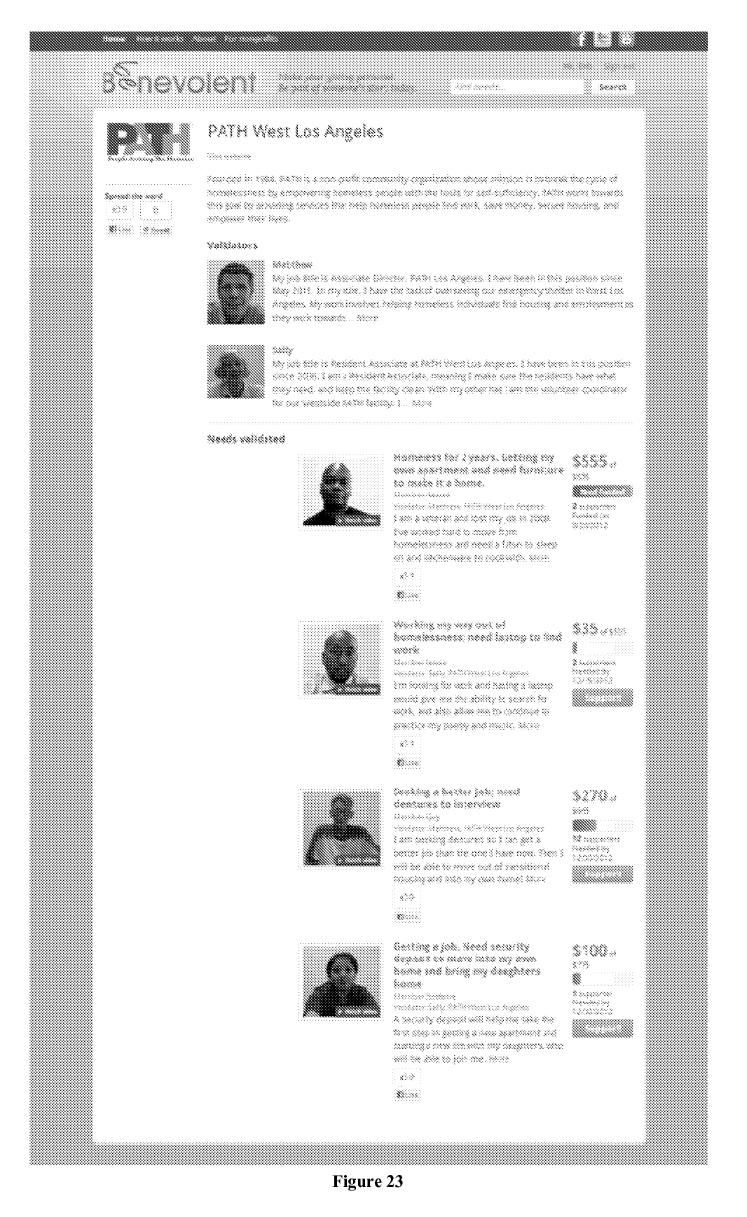

Any organization that wants to be a Local Connector may be authenticated and approved by Benevolent.net. An organization may first create a member account and then fill in a form to become a Local Connector (see e.g., FIGS. 21-23). Benevolent.net may, either manually or through a 3^{rd} party, authenticate the organization. Associated member accounts may show this designation. For example, on the associate member page, it may show up as “Benevolent Approved” organization. Once approved, the Local Connector account operator may add Local Validators associated with their organization (best seen in FIG. 23). A Local Connector may be required to have 501(c) status as a nonprofit entity, which may be indicated when applying as a Local Connector (see e.g., drop down “Additional options” bar in FIG. 22).

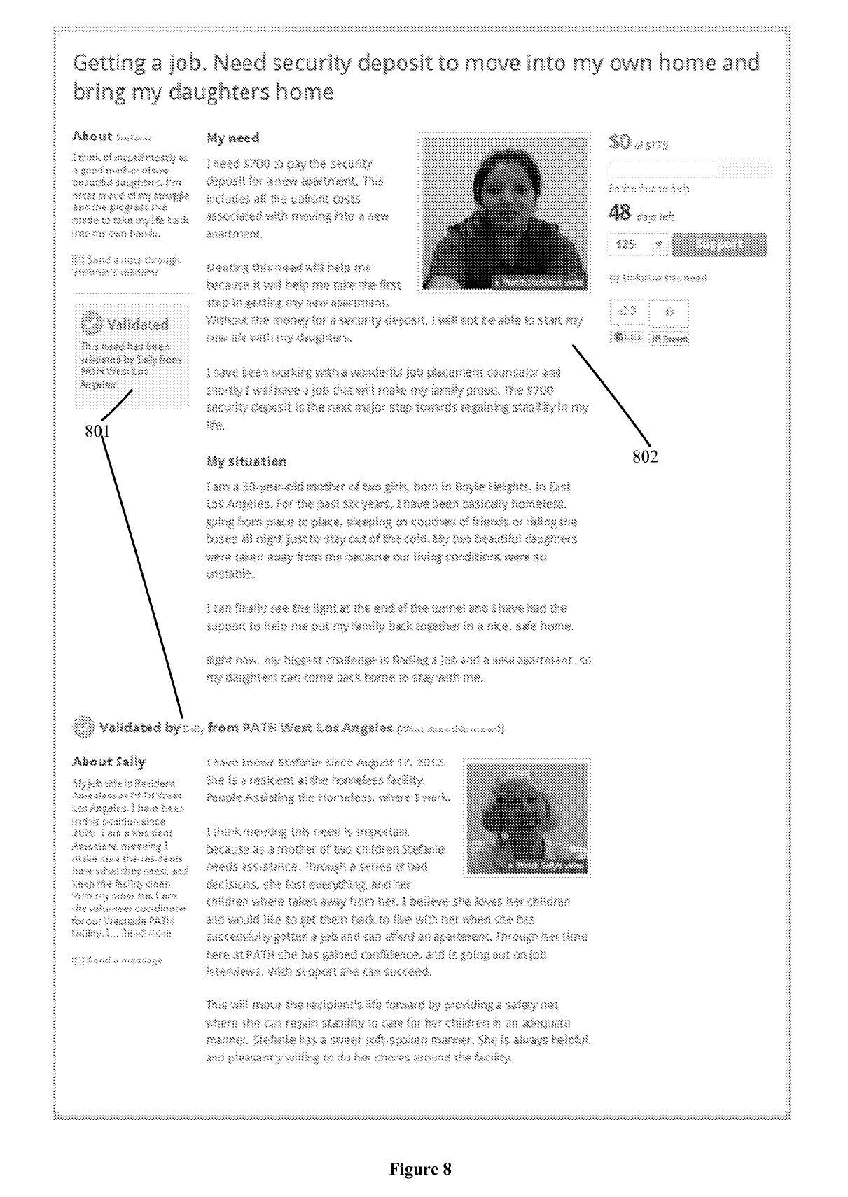

Any Member may be requested by a Beneficiary to become a Local Validator for a NEED. A Beneficiary may make this request at the time of creating the NEED in the system. The member who has requested to become a Local Validator may receive an electronic mail (hereinafter referred to as “BEmail”) with the request. Also, if the member who has been requested selects the need, a predetermined area (e.g., Left tool bar, right tool bar, center tool bar, top tool bar, bottom tool bar, etc.) may give “Accept”, “Reject”, and/or “Send Back” options to the Local Validator. The Local Validator may be able to send the request back to the Beneficiary with a message asking for one or more clarifications or for more details. If the member accepts the role of being a Local Validator for a NEED, the member may be asked to provide an organization's affiliation. Preferably, the member is already designated as a Local Validator in the Local Connector's account. An organization's affiliation may be linked to the NEED and/or with the member's account for future references (best seen in one or more display areas 801 in FIG. 8). If the member accepts being a local Beneficiary for a need, the member may be asked to provide an organization's affiliation.

There are several process steps involved in the creation of a NEED (see e.g., steps 1001 through 1005 in FIG. 1 and FIG. 12). Once a member has logged in, the predetermined area may have an option to create a new NEED for this user (best seen via the “Need” link at the top of FIG. 12). Upon clicking “Create a New NEED”, the user may be prompted to fill a checklist to identify themselves for a Local Validator. Once a NEED is entered into the system, it may be visible to the Local Validator (best seen in FIG. 13). In one or more embodiments, the Recipient can assign a NEED to a Local Validator (see e.g., “Validator Name” fields 1101 in FIG. 11). A BEmail message may be received by the Local Validator and also a section “My Validations” or “Needs Validated” may show up on or in a predetermined area (e.g., the left bar, the right bar, a top bar, a bottom bar, in the middle of the webpage (predetermined area 1401 best seen in FIG. 14), etc.) with the new NEED.

At this point in the process, there are several steps and decisions the potential Local Validator may take. First, the potential Local Validator may need to either “Accept” or “Reject” being a Local Validator for one or more Needs. If the Local Validator accepts the role of Local Validator, the system may ask the Validator to provide a Local Connector affiliation. In at least one embodiment, when the Local Connector affiliation is authenticated, the NEED may be accepted by the Local Validator. If the Local Validator Rejects to be the Local Validator, a BEmail may be sent back to the beneficiary with some explanation from the member. The member may ask for clarifications from Beneficiary before accepting the request to become a Local Validator.

As best seen in FIG. 13, once a member becomes a Local Validator for a NEED, they can approve or disapprove the NEED. In at least one embodiment, the Local Validator may approve or disapprove the Need by way of a “Validation Statement” 1301 explaining the reasons for the support or lack thereof. If the Local Validator has a video in support or in opposition to the Need, the video link may be provided in a predetermined area 1302. Additionally or alternatively, the Local Validator may ask for “additional information” and send the need back to the Recipient if the Local Validator does not have enough information to approve or disapprove the Need. The Local Validator may have an option to “Approve” a NEED. The Local Validator may be prompted to write a narrative affirmation of knowing the beneficiary and the Need's validity (see Validation Statement area 1301 in FIG. 13). The Local Validator may be prompted to upload a photo or video of affirmation (see e.g., address box 1302 in FIG. 13, which may additionally or alternatively function as an upload area). The Local Validator may be prompted to check off responses to a predetermined number of questions to help classify and/or prioritize the NEED. After Local Validator approves a NEED, the system may run a background check to authenticate the Local Validator (e.g., the system may determine if the Local Validator is listed under an organization's or Local Connector's profile in the system as shown in FIG. 23). Only after Local Validator has Approved a NEED and the Local Validator has been authenticated, a NEED is now in ready to be funded state, i.e., Members are able to start funding this NEED (see e.g., step 1003 in FIG. 1, diagram box 503 in FIG. 5).

The process of funding a NEED has several steps. First, a NEED has to be in APPROVED state to be funded. APPROVED NEED can be removed from that state by the Local Validator or an Administrator (see e.g., step 1003 in FIG. 1, diagram box 503 in FIG. 5).

The NEED amount may include any processing or other fees rolled into it. Any Member may fund an Approved NEED (see e.g., step 1003 in FIG. 1, diagram box 505 in FIG. 5 and FIGS. 16-17). Preferably, the member who created the NEED is not able to fund the Need. Alternatively, a member that created the NEED may fund an Approved NEED (e.g., if that member received funds from another entity already) and/or may designate an Approved NEED as being fully or partially funded through another party (see step 1005 in FIG. 1).

There are several contingencies for what happens if the funding time expires for a NEED (see step 506 in FIG. 5). One possibility is that the NEED may not be funded further, i.e., Members may not be able to add funds (e.g., the status of the NEED may be set to “FUNDED” as shown in step 507 in FIG. 5). Alternatively or additionally, the funding time may be extended. If the NEED has equal to or greater than a predetermined amount of requested funds (e.g., 75% or more fulfilled as shown in diagram step 509 in FIG. 5, 50% fulfilled, etc.), it may be considered FUNDED, i.e., Funds may be made available to the Beneficiary (best seen via steps 507 and 512 in FIG. 5). Preferably, the predetermined amount is 75% of the requested amount (as best seen in step 509 in FIG. 5). If the NEED has less than the predetermined amount of requested funds (e.g., 75% fulfilled, 50% fulfilled, etc.), it may be considered as NOT FUNDED (see step 508 in FIG. 5), e.g., Funds of Givers may be returned.

Preferably, a NEED may not accept more than 100% of requested funds, i.e., Givers may not be able to pledge for more than requested or pending request amount. Alternatively, a NEED may accept more than 100% of the requested funds should a donor wish to provide more than the requested amount or requested item(s). A NEED may be considered FUNDED if the funding time has expired and an amount greater than or equal to the predetermined amount of requested funds (e.g., 75% fulfilled, 50% fulfilled, etc.) have been pledged (see diagram areas 506 and 509 in FIG. 5). Also, a need may be considered FUNDED if the NEED has received 100% of requested funds.

Once a NEED is considered FUNDED, the next steps to transfer funds to Local Connector may then be initiated. The one or more Givers, the Recipient and/or the Local Validator may be sent a message about this status change and one or more funding details. Local Validators and Recipients may be sent special messages on next steps they need to take to get the funding to the Recipient.

In the case where a NEED is NOT FUNDED (see box 508 of FIG. 5), there are several process steps which may be taken. A NEED may be considered NOT FUNDED if funding time has expired and less than the predetermined amount of requested funds (e.g., 75% fulfilled, 50% fulfilled, etc.) of requested funds have been pledged. Any pledged funds may be returned back to the Givers along with an explanation and/or a request to re-allocate. An explanation may be sent to the Beneficiary and the Local Validator; the explanation may include suggestions for resubmitting NEED with different narrative, lower cost, or other modified field of information so that the NEED may be met. The NEED may be moved to a special state—NOT FUNDED.

NEED follow-up may be communicated via BEmails in Benevolent.net system. Each NEED, when funded, may have its own community/network formed automatically. Givers may have an option to receive these messages. Givers can send a message directly to the Beneficiary or Local Validator, but not to another Giver directly within a NEED based community. Alternatively, should an administrator, such as a Local Validator, permit such an option, Giver may be able to send a message to another Giver directly, e.g., to coordinate efforts to efficiently meet and fulfill the NEED. Local Validator may send a message directly to the Beneficiary and/or to the Local Validator. A Beneficiary may only be permitted to send a message back to the Giver in Response to a received message. A Beneficiary may send a message directly to the Local Validator. Beneficiary and Local Validator can post photos, video, links and comments about the progress on the NEED. Givers may also post photos, videos, links and comments.

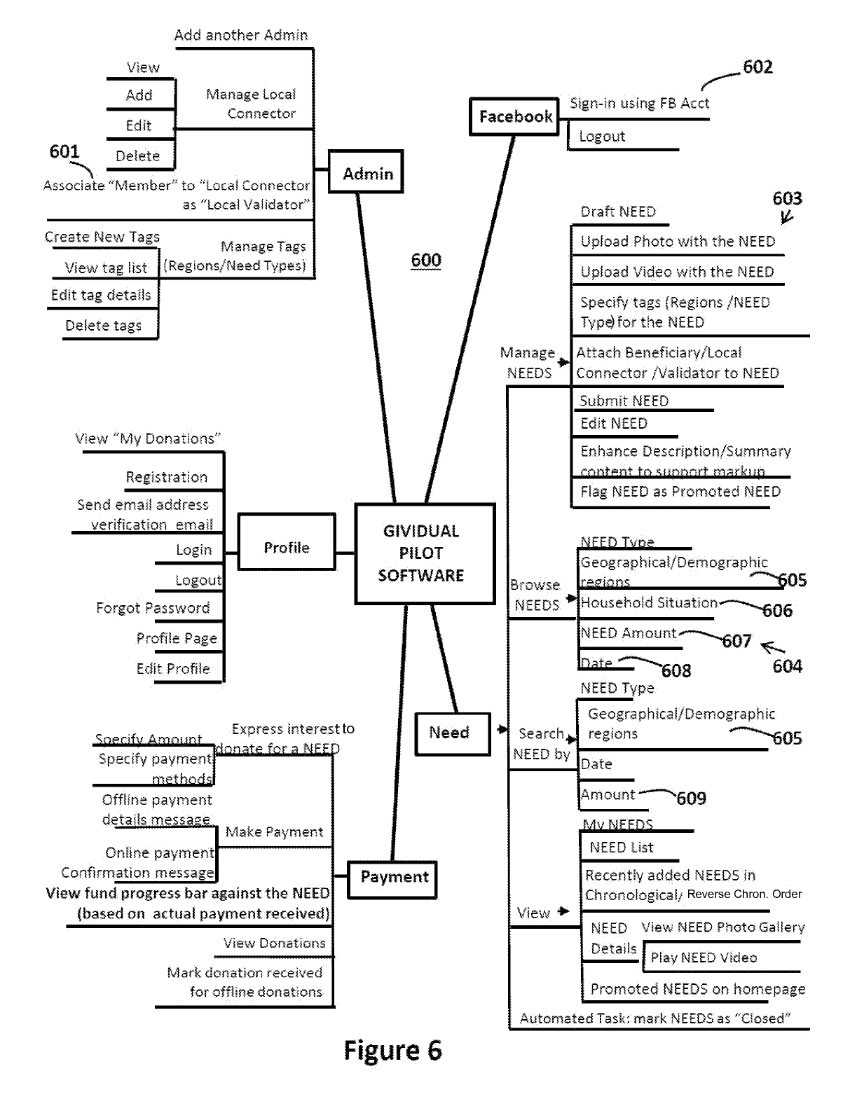

Several parameters may govern the search mechanisms for locating a NEED. All members may be able to view one or all the needs in the system. The needs list may rotate the display of the needs therein, e.g., on a round-robin basis, randomly rotated, etc. The invention may learn a user's preferences over time and may determine what needs to list or not list based on same. A “short-list” or “shopping car” may be used to keep track of the NEEDS one is interested in prior to donation (best seen in FIG. 5). As shown by the pilot software functionality fields in area 604 of FIG. 6, one or more search Options may be provided to view one or more needs by one or more of the following: Geographical/demographic Regions 605, household situation 606, Need Amount 607, Date 608, Amount 609, Latest NEED first, Oldest NEED first, Approved NEEDs only, “Yet To Be Approved” Needs only, etc.

A NEED community may be very specific to a NEED. Members in a NEED community may include one or more of the following: a Recipient, a Local Validator, a Local Connector Organization or Givers (see e.g., FIG. 8). A NEED community may be created automatically. Members in a community may be linked via the NEED. All communication may be 1:1 or 1:Many, (i.e., messages sent by a member in a NEED community may be sent to one or ALL members in that NEED community). Other users may “follow” the NEED community without being members until they donate.

There may be many ways in which Members can connect. Member connections may be one-to-one connections between members, e.g., at Benevolent.net. Any Member may initiate a connection with another Member, if that Member has not blocked incoming connection requests. Members may be able to view online “friend” Members via a “friends list” to which a Member is added after making the connection. A new connection request may show up on the predetermined area, e.g., the Left Side tool bar, the Right Side tool bar, a Top tool bar, a Bottom tool bar, etc.

A member can Accept, Reject, and/or Archive a connection request. If the connection request is Rejected, there may be an option to reject all future requests from the requesting member. If the connection request is archived, a member can revisit it within a predetermined time period (e.g., two weeks, 1 month, 2 months, 6 months, a time set by the member, etc.) and then either Approve or Reject same. If the connection request is approved, members may now send BEmails to each other. Connected members can send each other requests to join the communities to which they belong.

Members may be able to create their own Member Communities. Communities may be OPEN or CLOSED. ALL members at the predetermined location, such as Benevolent.net, may be able to join any OPEN community. CLOSED communities may require approval from the Community owner. A message sent by a member in one community may be sent to one or ALL members in that community.

There may be special needs created by the Administrator. These special NEEDs, or Super NEEDS in the system—i.e., a local community wide need. These special Super NEEDs may have a description and a Latest Date, but no NEED amount. Alternatively, the Super NEEDs may include a NEED amount or description of a needed item(s). These special Super NEEDS may go through several stages, e.g., NEED creation (no approval needed) (see e.g., box 510 in FIG. 5), NEED open for Local Connectors, NEED open for Beneficiaries, NEED being funded, etc. Such special Super NEEDS can have more than one Local Connector organizations, and they can get associated with the NEED when the NEED is open for Local Connectors. Local Connectors may be approved by the Administrator (see box 511 in FIG. 5). Beneficiaries may be able to create a NEED and link it to a SUPER NEED. Beneficiaries may still need to provide a Local Validator for that NEED. Each Super NEED can be linked to multiple NEEDS that multiple Beneficiaries may create; a limit per beneficiary household may be implemented. Givers may be able to pledge for either a Super NEED or associated NEEDS. Since there may be a time lag between the Super NEED creation and Beneficiary NEED creation, any amount or item(s) pledged to the SUPER NEED may be available to be associated with a Beneficiary NEED (for that Super NEED) before the Latest Date. For example, Givers can pledge for Super NEED, but can allocate that pledge for a Beneficiary NEED before the Latest Date for the Super NEED. At the Latest Date, any amount or item(s) not associated with Beneficiary NEEDS may be distributed equally to the Local Connectors to be used for the Super NEED.

An administrator, such as a Benevolent.net administrator, may have an option to create a Special Community NEED which may or may not be associated with another member (e.g., may be associated with the administrator). This NEED is related to a community and can have one or multiple Local Connectors associated with it. Givers can choose to send funds to one Local Connector, or may have an option to split funds equally amongst all (or one or more) Local Connectors associated with this NEED. Additionally or alternatively, givers can set the amount of funds or item(s) to be allocated amongst the Local Connectors. Givers and Local Connectors may automatically become part of this NEED based community. Local Connectors may be able to send updates on their work to this NEED based community.

A flow diagram illustrating one or more possible interactions and functional roles within the Gividual system and based on one or more of the aforementioned steps in one or more embodiments of the present invention is shown in FIG. 5.

Steps and/or actions may be performed manually and/or automatically by the invention. An example of software that may be employed to perform the aforementioned steps is illustrated in FIG. 6. This figure describes various functional areas of the Gividual software system.

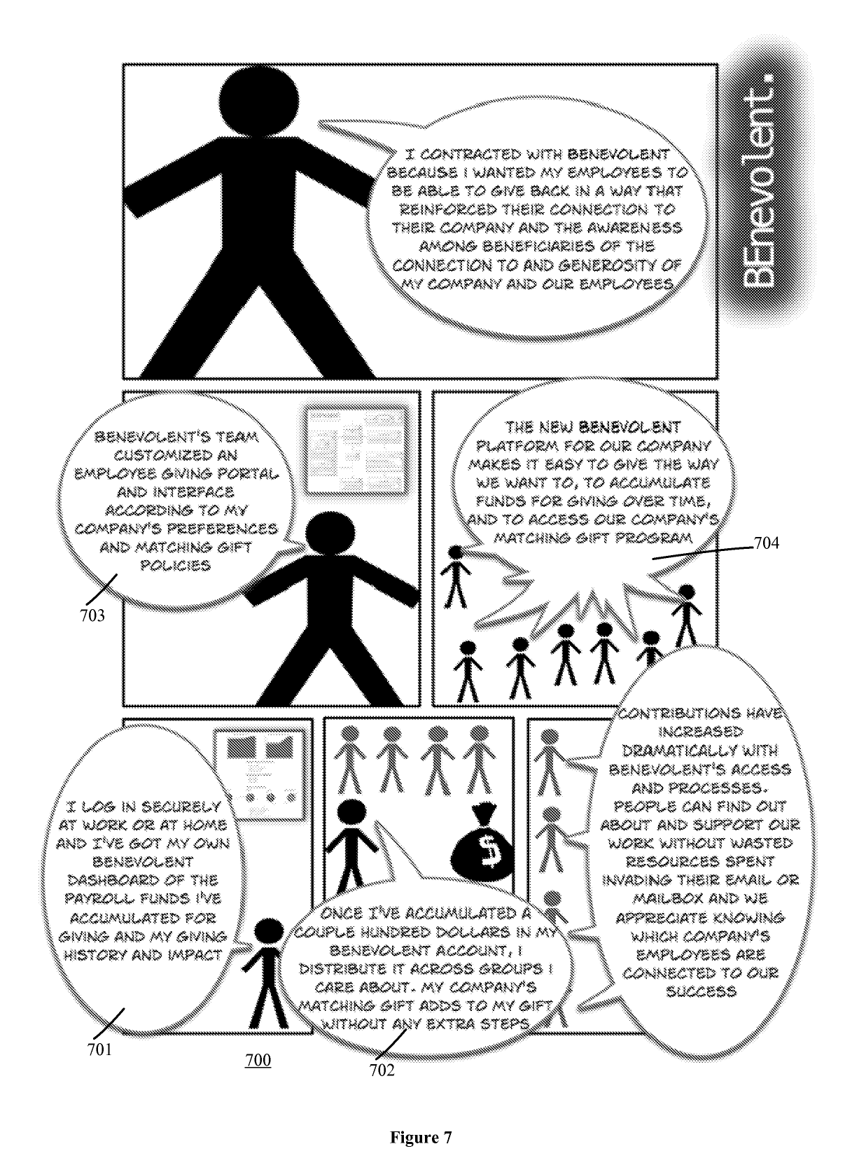

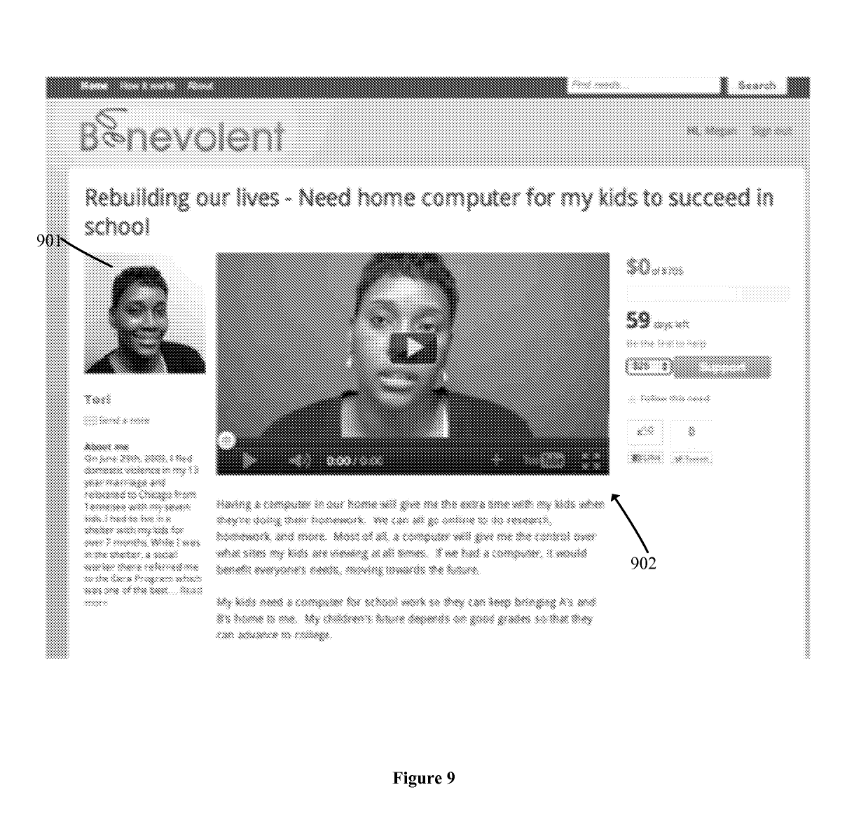

FIG. 7 shows one embodiment of the Gividual software system 700 being used in a corporate giving environment. An example of several NEEDs and user interfaces for inputting data for such NEEDS are shown in FIGS. 8, 9 and 10. FIG. 8 shows a sample of the visual representation of a NEED (see area 802 on the webpage), as well as details about the NEED validator and the NEED validation (see predetermined areas 801 on the webpage). FIG. 9 details a Sample Page for a Recipient 901 and Personal Video 902 of their NEED.

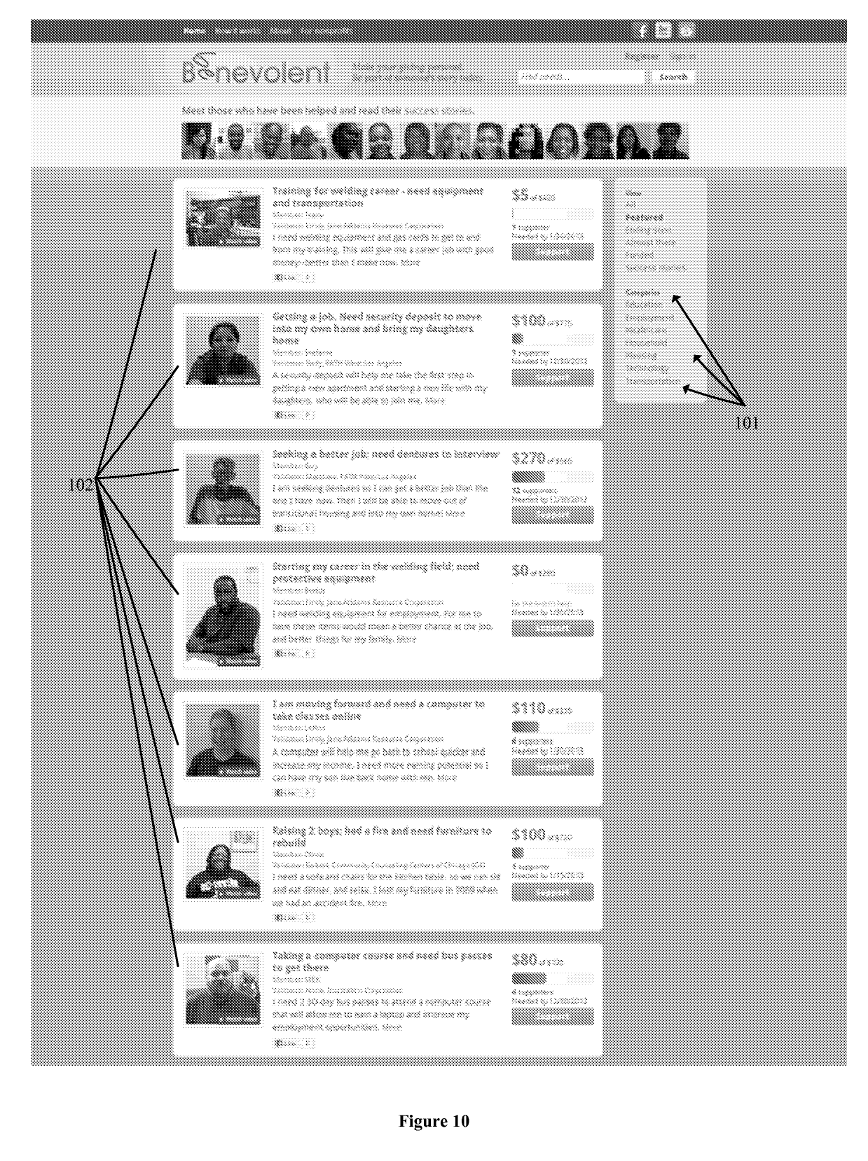

FIG. 10 shows the diversity of NEEDS which may be listed on the Main Home Page and the possible criteria for selecting a need, including the need category 101 (i.e., technology, transportation, etc.) and an example of how the needs may be displayed 102. FIG. 11 shows an example of one or more data entry fields (see e.g., Validator Name field 1101; email address field 1102; nonprofit name field 1103; etc.) for questions which may be asked of a beneficiary when information is being entered for his/her NEED. Such information may include at least one of: personal details and demographics, personal story, special circumstances and details about their NEED and how it fits into their story. FIG. 12 shows an interface where details of an individual's NEED may be described in their own words (see e.g., Title field 1201, Short summary field 1202 and Longer Description field 1203). An important piece of uploaded information about a NEED is a video containing explanation by the Beneficiary of their circumstances and how having their need met will move them forward toward their goals (see e.g., video 902 in FIG. 9).

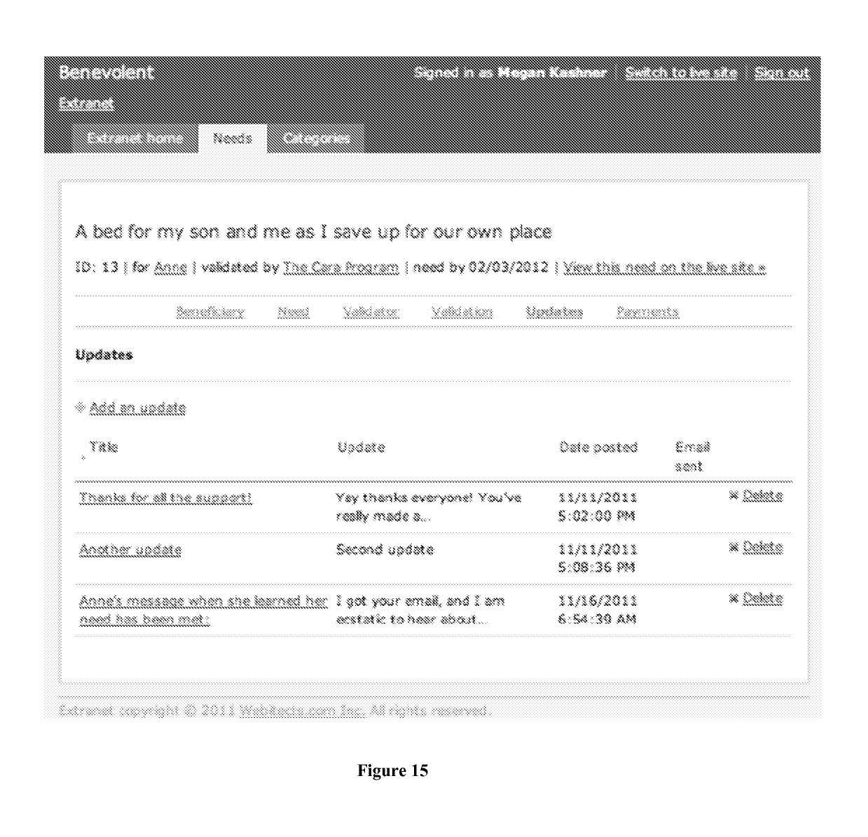

An important part of the methodology is the validation of NEEDS by a qualified Local Validator. FIG. 13 shows a sample of information that is input by a NEED validator, as he/she describes his/her relationship with the Beneficiary and explain how having this particular NEED met will move the Beneficiary towards independence (see the Validation Statement field 1301). The process may include a video upload or a video address link (see field 1302) of a Validator discussing their Validation in his/her own words. FIG. 14 shows a visual representation of how the Validation page may be displayed for potential Donors when reviewing a NEED. Once criteria are satisfied for a FUNDED NEED, the status of the need being funded is adjusted within the system (see e.g., steps 506-509 in FIG. 5). As a NEED Community is created by the Beneficiary and Donors, one or more updates and communications may be posted to facilitate connectedness between members of the NEED community. Examples of updated communications will be shown on a Beneficiary's NEED profile (best shown in FIG. 15).

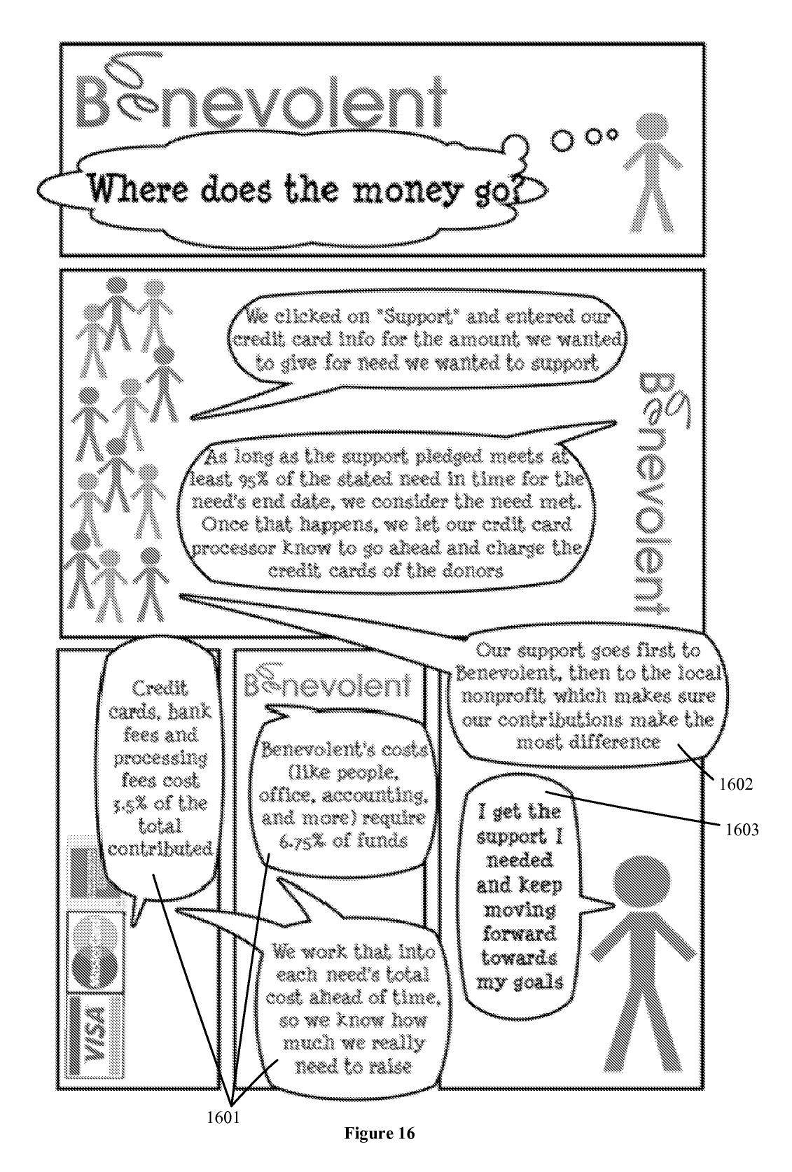

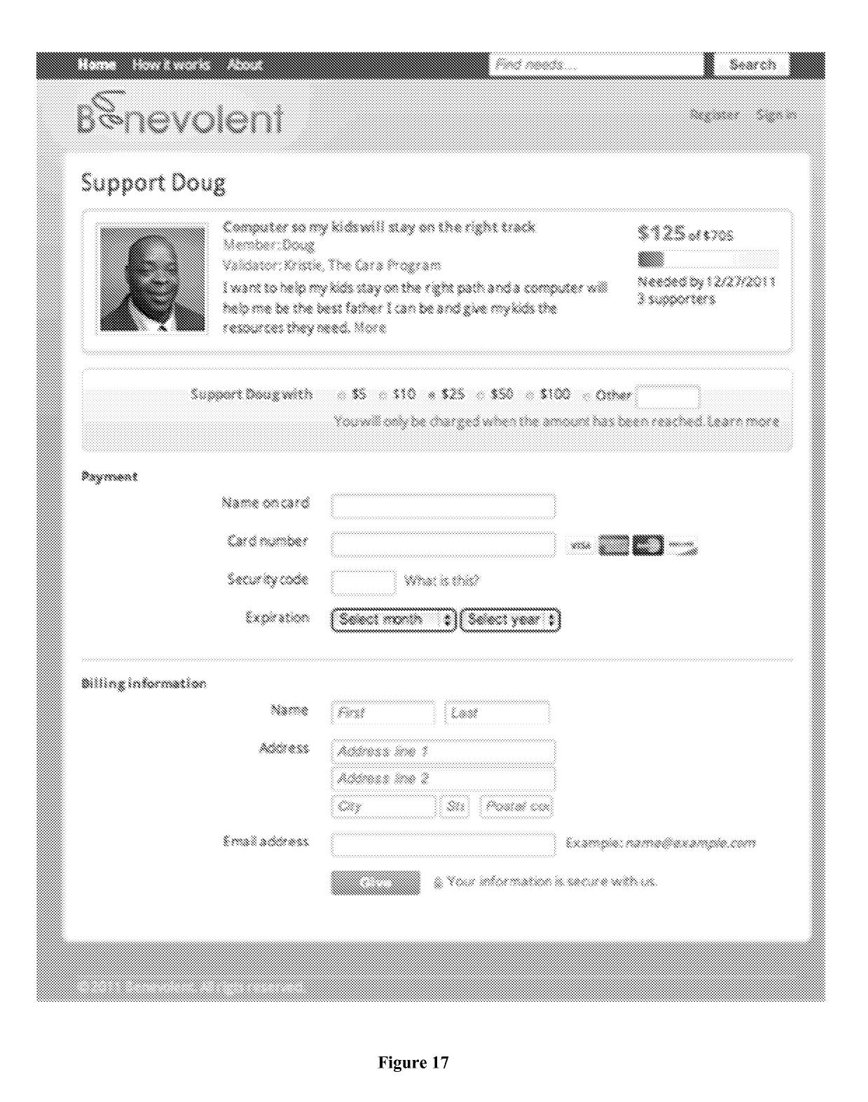

Relative to Financial Transactions, Members may be able to use their Credit Cards for a one time pledge (best seen in FIGS. 16-17). Members may store Credit Card information in a secure account so that the members do not have to reenter the Credit Card information every time they make donation(s). Members may be able to use a third party clearinghouse account to make a one-time pledge. Once members make a pledge for a NEED, their account may be debited. If a NEED is not funded, the member's account may be credited with the pledge amount (see e.g., step 508 in FIG. 5). One or more pledge amounts may be kept in a Special Account managed by Benevolent.net. Each pledge transaction may be appended with a unique NEED ID. When a need is funded, an administrative charge may be applied to the total funded amount and this amount may be transferred to Benevolent.net's account (see step(s) 1601 in FIG. 16). When a NEED is funded, the total amount minus administrative charge may be transferred to the Local Connector's account (see e.g., step 1602 in FIG. 16).

Local Connectors may be responsible for transferring the pledged amount to the Beneficiary (see e.g., step 1602 in FIG. 16) and upon doing so, may send a confirmation message to Benevolent.net Administrative account. A Beneficiary may also send a confirmation to Benevolent.net's Administrative account when the pledged amount is received by them. If either of the confirmations is not received after a predetermined time, Benevolent.net's Administrative account may send one or more reminders to the account that has not sent confirmation. If either confirmation is not received after a predetermined time, a flag may be raised for the account for a Benevolent.net Administrator to take action.

One or more financial transactions for a NEED may be considered complete when the Beneficiary has acknowledged receipt of a pledged amount (minus the administrative fee) (see step 1603 in FIG. 16), the Local Validator has acknowledged transfer of pledged amount to Beneficiary and the Admin. charge has been transferred to Benevolent.net's account. One or more of the aforementioned details of where the money goes are illustrated in FIG. 16.

The format of financial transactions may be provided by Benevolent.net for using in fulfilling donations managed by the Gividual system. As aforementioned, an administrative charge may be applied on the total funded amount for a NEED (see step 1601 in FIG. 16). An administrative charge may be retained in the Benevolent.net account when amount is being disbursed to the Local Connector (see step 1601 in FIG. 16). With Recurring Pledges, members may be able to manage Credit Card data that they provided to Benevolent.net. Members may be able to store Credit Card information for future reference (see FIG. 17). Members may be able to remove Credit Card information. Members may be able to manage their 3rd party account ID for future reference, and may be able to manage a selection across an array of giving interests and preferences.

As best seen in FIG. 7, monthly transfers or payroll transfers to accrue giving balances for distribution may be done through the Member Home Page (see e.g., step 701 in FIG. 7). Members may respond to a need or email alert or when no balances have accrued. Balance alerts may be implemented to alert to set balance or to prompt distribution. There may also be an automatic distribution option settings where Member Donors may set up a portfolio of pre-selected organizations or balanced portfolio according to preferences (see e.g., step 702 in FIG. 7). Members may be able to set receipt settings per transaction, monthly, end-of-year, etc. In addition, the Member Home Page may contain employee match claim links and receipting which would make it easy to submit for employee matching funds (see steps 701-704 of FIG. 7).

Additional clarification and details of permissible roles, relationships and interactions, as defined by the invention's capabilities and functionality are as follows:

As best seen in FIG. 6, members may create an new user/member/regular account at Benevolent.net. They may log into Benevolent.net using an existing account at Benevolent.net. Members may create a new user/member/regular account via a popular social network site authentication. Members may log into Benevolent.net using an already authenticated social networking account. They may also browse through one or all NEEDS and can search, sort, and/or filter NEEDS.

A member has the option to become a Giver, Recipient and/or Local Validator for a NEED.

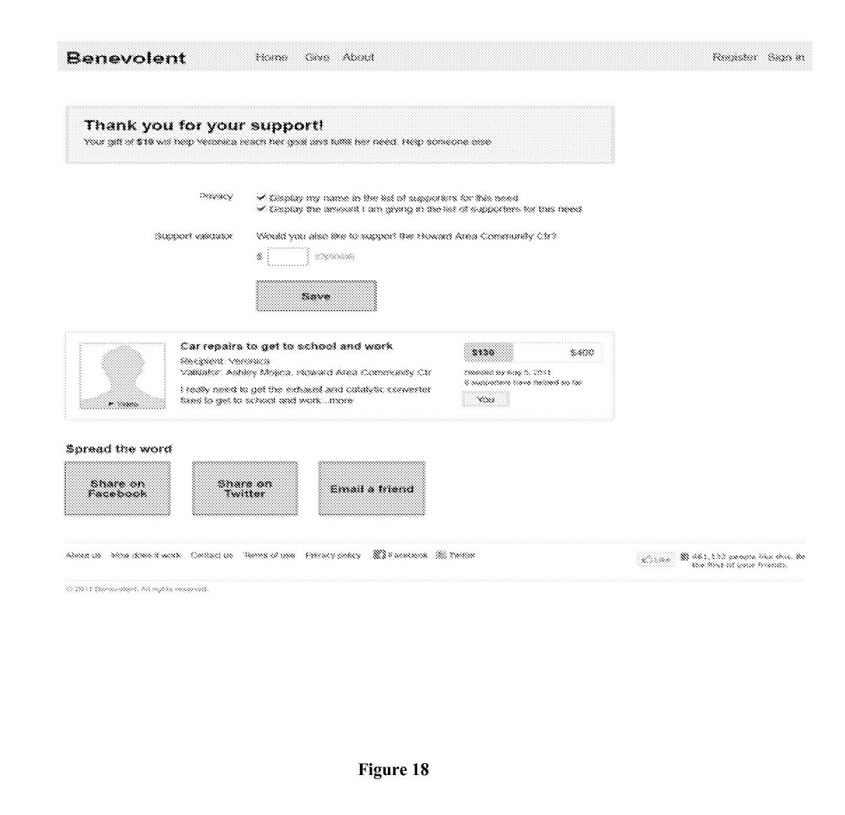

Donors may be a Member of Benevolent.net and they may fund part or whole of a NEED. FIG. 17 illustrates a visual representation of a page where Donors may pledge support for a NEED. Subsequently, Donors may choose to share details of their giving on their preferred social media sites. FIG. 18 shows an example of at least one visual representation of a page where Donors may share their actions through social media. Donors may send messages to Beneficiary—before or after a Beneficiary's need has been Funded. Donors may also receive messages from Beneficiary—before or after a Beneficiary's need has been Funded. Donors may send messages to the Local Validator of a NEED for clarification(s) and receive messages from a Local Validator with clarification(s). Donors may choose to remain anonymous while communicating with a Recipient on a per NEED basis and they may also choose to remain anonymous regarding an amount donated. This functionality may be independent from whether the Giver wishes to remain anonymous for one or more communications.

As shown in FIG. 18, donors may publicize a Recipient on their social networks. Donors may sign-up to receive updates from a Recipient on a per NEED basis, for which they are a Giver. Donors may have the option to NOT receive any updates from a Recipient on a PER NEED basis. Donors may need a Credit Card or PayPal/GoogleCheckout account to fund a need (see e.g., FIGS. 16-17). The Donor role may be applicable on a need basis, e.g., a member may be a donor only for a NEED which he/she has funded, for all other NEEDS, the role may remain that of a regular member.

A Beneficiary or Donee may be a Member of Benevolent.net. The Beneficiary role may be applicable on a need basis, e.g., a member may be a Beneficiary only for a NEED which he/she created. Beneficiaries may send messages to Givers—before or after a NEED has been Funded and they may also receive messages from a Donor/Givers—before or after a Donor or Giver has funded a NEED. Beneficiaries may send messages to Local Validator with clarification(s). This may be in response to queries from a Local Validator. Beneficiaries may also receive messages from a Local Validator for clarification(s). This may be to request further information or to make changes to a NEED proposal. Beneficiaries may choose to remain anonymous while communicating with a Giver. Beneficiaries may need a Bank Account to receive funds via a Local Connector. Beneficiaries may need to acknowledge receipt of funds from the Local Connector. Beneficiaries may be required to provide receipts of purchases and expenses to the Local Connector when their NEED has been fulfilled.

A Local Connector preferably is a 501(c) designated organization (see “Additional options” field 2201 in FIG. 22). This status may be validated automatically and/or regularly. Preferably, the Local Connector has an active EIN. This may be validated automatically and/or regularly. The Local Connector may have a signed a contract to be a Local Connector with Benevolent.net. Preferably, one or more Local Connectors provide a mailing address, a primary contact, their email, and a phone contact (best seen in FIG. 22). In at least one embodiment of the invention, a Local Connector provides Bank Account information to Benevolent.net to receive funds which may be disbursed to the Beneficiary. Local Connectors may provide an acknowledgement to Benevolent.net of receipt of funds. They may also provide to Benevolent.net an acknowledgement to a transfer of funds to the Beneficiary. A Local Connector Account may be able to populate Local Validator Information.

The Local Validator may be a Member of Benevolent.net. He/she may be affiliated with a Local Connector. This may be validated automatically and/or regularly. Local Validators may send one or more messages to Beneficiary for clarification(s). A Local Validator may receive one or more messages from a Beneficiary with clarification(s). A Local Validator may not be anonymous as a validator of a NEED. The Local Validator role may be applicable on a NEED basis, i.e., a member may be a Local Validator for a NEED for which they are designated a Local Validator, for the rest of the needs they are a regular member.

An Administrator's account may never be deleted. This may be a super user account. An Administrator may delete any message in the system—if it is designated to be deleted. They may create or delete member accounts. ALL administrator account activity may be logged. These one or more logs cannot be deleted. Logs may need to be stored for a predetermined duration. Log details, such as format, may be set to meet one or more compliance requirements. As aforementioned, Administrators may be able to create special NEEDS.

A computer-readable storage medium, such as, but not limited to, a hard disk, a flash memory, a CD, a DRAM or the like, an optional combination thereof, a server/database, etc. may be used to cause a processor, such as, but not limited to, the at least one first processor 3, the at least one second processor 5, etc. to perform the steps of the methods disclosed herein. The computer-readable storage medium may be a non-transitory computer-readable medium, and/or the computer-readable medium may comprise all computer-readable media, with the sole exception being a transitory, propagating signal. The computer-readable storage medium may include media that store information for predetermined or limited or short period(s) of time and/or only in the presence of power, such as, but not limited to Random Access Memory (RAM), register memory, processor cache(s), etc.

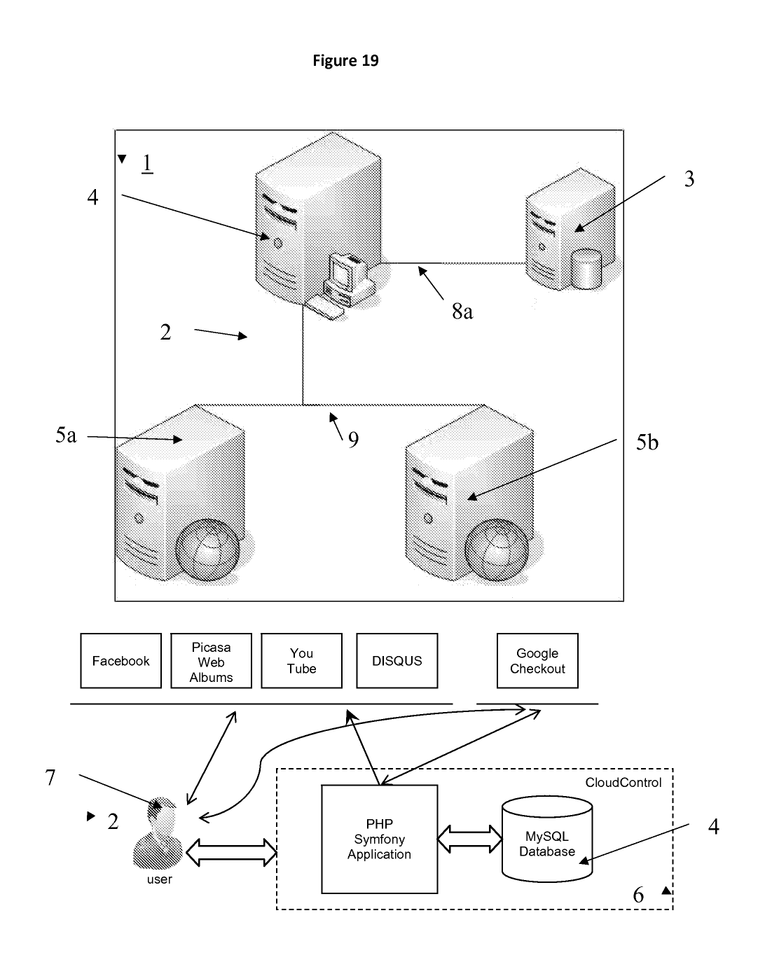

FIG. 19 shows a schematic view of a system 1 for processing the allocation of donation(s) as discussed above in accordance with one or more aspects of the present invention. The system 1 includes at least a first processor (also may be referred to as a “computer”) 3 and a one or more second processors (also may be referred to as a “computer”) 5a, 5b. The processors 3,5a, 5b may be located in the same telecom network or in different telecom networks. The first processor 3 operates to permit a donee/beneficiary to connect to and upload information to a database/server 4 to create a NEED as discussed above. The database/server 4 may comprise a processor to properly handle and store the data from the donor/donee. The one or more second processors 5a, 5b operate to permit a donor/member to connect to, search for and donate to a created NEED as discussed above (e.g., over communication links 8a and 9, etc.). The first processor 3 and the one or more second processors 5a, 5b may permit users 7 thereof to communicate directly. A user 7 may connect to the database 4, which may be, but is not limited to, a MySQL database, via a network connection 8a, 9 (e.g., such as via CloudControl software, directly over communication links 8a and/or 9, etc.).

In accordance with at least one aspect of the present invention, the methods, systems, and computer-readable storage mediums related to the processors, such as, but not limited to, the at least one first processor 3, the one or more second processors 5a, 5b, the processor of any of the computers discussed herein, etc. may be achieved utilizing suitable hardware, such as that illustrated in the figures. Functionality of the invention may be achieved utilizing suitable hardware, such as that illustrated in the FIG. 19. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. The processors 3, 4, 5a, 5b (as shown in FIG. 19) may also include and/or be made of one or more microprocessors. Still further, the various aspects of the invention may be implemented by way of software and/or firmware program(s) that may be stored on suitable storage medium (e.g., computer-readable storage medium, hard drive, etc.) or media (such as floppy disk(s), memory chip(s), etc.) for transportability and/or distribution.

Further considerations for developing one or more embodiments of the invention may include one or more of the following 3 unique roles:
UI-Creative
Middleware-architect
Database-data base admin and/or architect

Administrators of the invention may be located locally, nationally or internationally (e.g., across one or more telecom networks).

The messaging system may be completely contained within the site, a member may get notification in email that there is a message. The messaging system may forward messages to one or more external email accounts. Depending on the needs of the community using the invention, emails may be allowed to, or prohibited from going to, outside of the apparatus or system of the invention. Preferably, replying to a message requires going into the system of the invention. Messaging ecosystem may be controlled within the site. Intra-site messaging may be used as well. Parties that choose to be anonymous may disable communication/connection to Facebook or any other social network that may be associated with their profile of the website. All messages may be TAGGED as either sent directly to a member or via a group/community broadcast.

While not limited to the following details, the following descriptions illustrate various details that may be included in a website or user interface for providing and/or performing the aforementioned method actions/steps in one or more embodiments of the invention:

Benevolent colors may be Blue and Orange, and per-page use may not exceed more than 3-4 colors. Multiple colors in photographs may be permissible. Text may be in black and font size may be larger than that at Facebook or may be any predetermined size or color. The whole screen may be utilized, leaving no spaces at the sides. Screen design may be simple with empty spaces for readability. There may or may not be flashing objects. Items may only change when a user clicks or hovers. The number of photographs and image objects on a page may be limited to keep the one or more screens simplistic.

Members may be able to access all information with minimal clicks. Search results may be accompanied by applicable filters. A Left section of the main view may have tools for users, e.g., search filters, message box, etc. A Middle section of the main view may have user feeds (see e.g., FIG. 15).

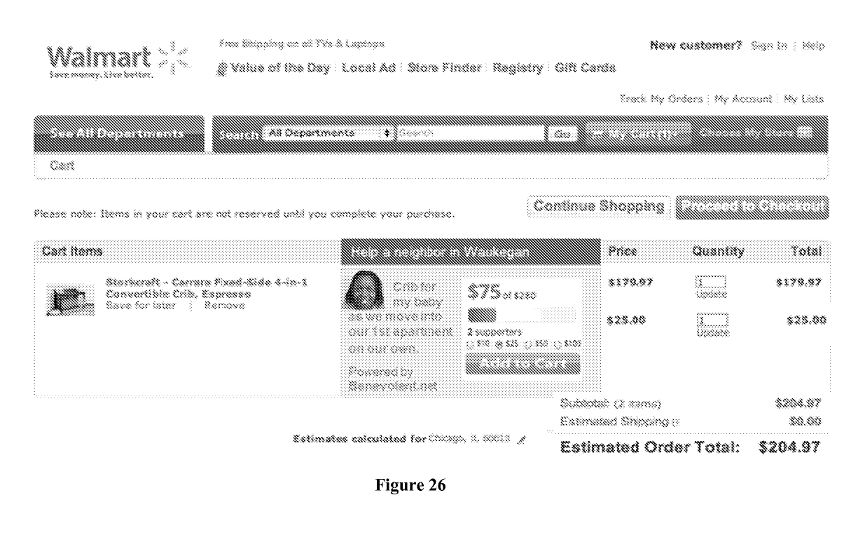

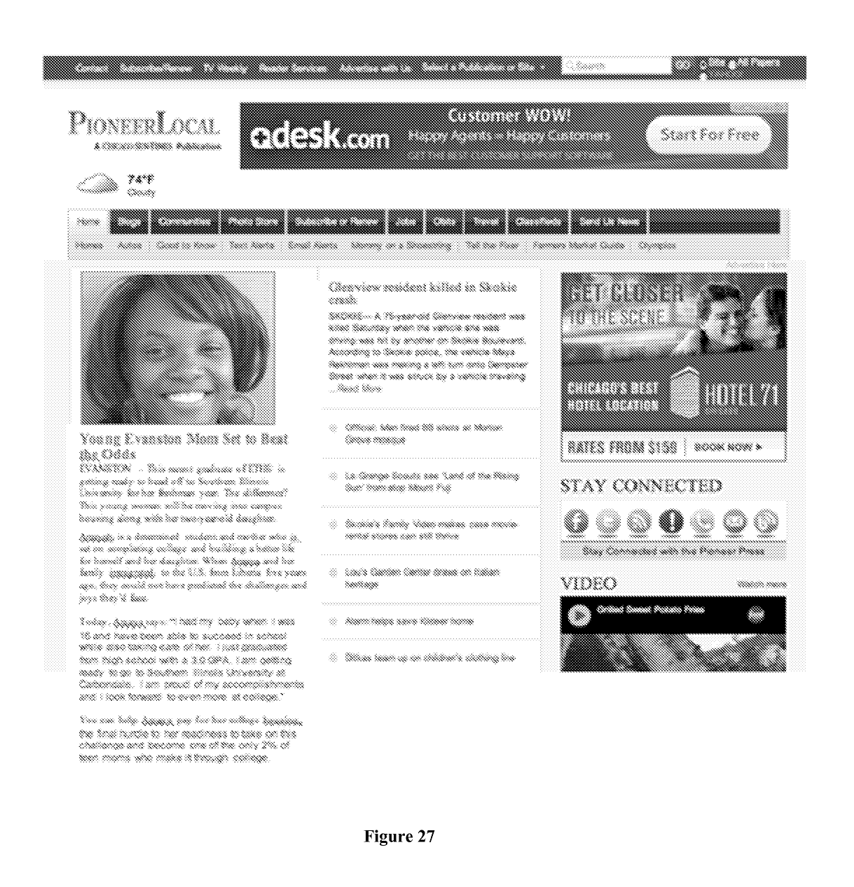

A Right section of the main view may have stories. One or more versions may likely have provision for Advertising space (best seen in FIGS. 26-27). A Top section may have site navigation and search option. A Bottom section may contain sections About Benevolent, Blog, etc. and may denote “Powered by Gividual Platform”.

The Main Home Page on one or more websites of the invention may keep content to a minimum. The Main Home Page may explain Benevolent.net's message and proposition in its use of the Gividual platform. The following functionality may be provided on the Main Home Page:

Login using an existing Benevolent.net ID, Login using a popular social network ID, Creating a new benevolent.net ID and getting authenticated via a popular social network ID (see step 501 in FIG. 5). As best seen in FIG. 10, the Main Home Page may contain one or more links and sections such as, but not limited to: “how it works”, “about” or “about us”, “why”, “my portfolio”, “blog”, “community”, “sponsorship ads” and “pay-to-post stories” on the right of the homepage, “highlighted individual”, “group and nonprofit needs”, “highlighted benefactors”, “other campaigns” (e.g., disaster relief links, highlighted impact on one community or issue area) “facts and stories about poverty”, “need”, “policy” and “giving”.

The Member Home Page may display personalized content. Certain demographic/geographic information may be collected including, but not limited to: age, gender, race, culture, geography, income range, family size (children's ages), marital status, other orientations (e.g., LGBT, trans, disabled, cancer survivor, etc.). There may also be a section for a Member to discuss how benevolence has played a role in his/her life through social services, churches, schools, after school programs, sports, healthcare, hospitals, aid, generous individuals, etc. This section may be limited to a predetermined number of words, such as, 500 words. Members may also choose to post photos or images in their personal profile.

The Member Home Page may also display a member's network updates. A Left side section may have tools, BEmail message notifications, search filter (when search is performed). User tips and success stories may be located on the right side of the site. Stories may be changed by the user, e.g., by scrolling. Navigation may be located on top of the website. based on giving interests and history. The Member Home Page may also include account management, giving, need search, need filters for need categories or organizations to always include or exclude, etc. (e.g., starts to look more like online banking/investing) portfolio metrics on giving history, highlighted needs based on giving preferences and history, messaging content, tracked beneficiaries and organization's updates and news (e.g., like a newsfeed).

As part of account management, the Member Home Page may also have capability to manage Message Settings so that members can manage receipt preferences (per donation or year-end, for example) and email alerts to messages received. Relative to giving portfolio account management, a donor may set a list of nonprofit ongoing campaigns to give a pre-determined sum to each quarter out of either accrued balances or one or more stored credit cards. Relative to regular distributions to a giving list, a donor may set clear preferences and rules for giving and the invention's algorithm distributes giving across campaigns each month/quarter. Relative to distributions of accrued funds for giving, the Gividual platform may prompt a donor to visit to determine distribution of accrued balance on a predetermined timeline. Default giving options may be set upon certain time expirations.

The Member Home Page may also contain the ability to search by keyword or by checking boxes regarding giving interests and restrictions based on personal values. Search results may appear without preference for higher values or anything. User may be able to sort based on factors. Search may generate right-hand column ads and paid content. Search preferences may be saved or cleared and recently viewed needs feature and identification of others who searched for these interests and who they supported. Members will access their shopping cart of NEED or CAMPAIGN donations in a manner very similar to a retail online cart of purchases. There may also be links to social media sites for Members who want to share their stories and donation giving experiences over their networks may do so easily with social media links. CAMPAIGNS or NEEDS in a cart may go to checkout for payment of the selected amounts, they may be placed in a portfolio for distributed giving and they may be placed on a list of tracked campaigns for updates and alerts. These tracked campaigns may be “Liked” or “Followed” by friends through social media.

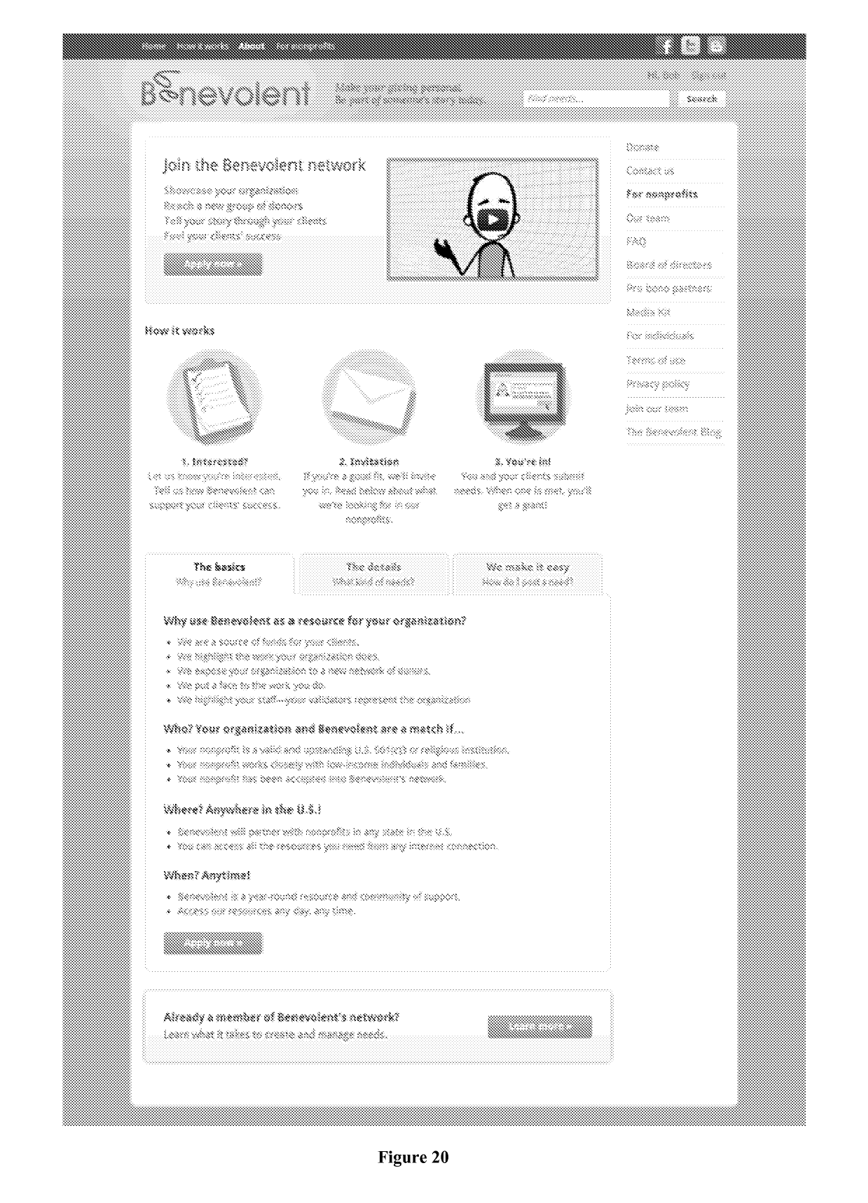

Local Connectors may first enter into the Gividual platform through a portal designed to direct them through key information that needs to be collected in order to serve as a Local Connector. A visual representation of this portal for Local Connectors is shown in FIG. 20. There may be an interest form where the Local Connector can express their interest in becoming a Local Connector. FIG. 21 shows the data entry process for Local Connectors to express interest in becoming part of the network. The Local Connector (NonProfit Organization) Homepage itself will contain all relevant information for the Local Connector's profile and may include the following, but is not limited to: Contact Information, Organization Leadership, email contacts, EIN, and tax exempt status category. It may also contain a brief overview of the organization which may be limited in length. There may also be a Narrative portion of the Local Connector Homepage which contains the organization's mission, history, vision and program overview. The organization may also include a section on the Local Connector Homepage which contains Offerings and Client overview including group, percentage breakdowns of categories of clients and descriptions. The Local Connector may also post indicators of organizational health, including financials and number of employees, locations, etc. There may also be a section where the Local Connector can upload their logo, photos, staff overview, link to the organization's website, etc. FIG. 22 shows the data entry process for creating a Local Connector Homepage. There may settings available on the Local Connector Homepage which allow the organization to determine message settings, payment settings, etc. An example of a Local Connector Homepage can be seen in FIG. 23.

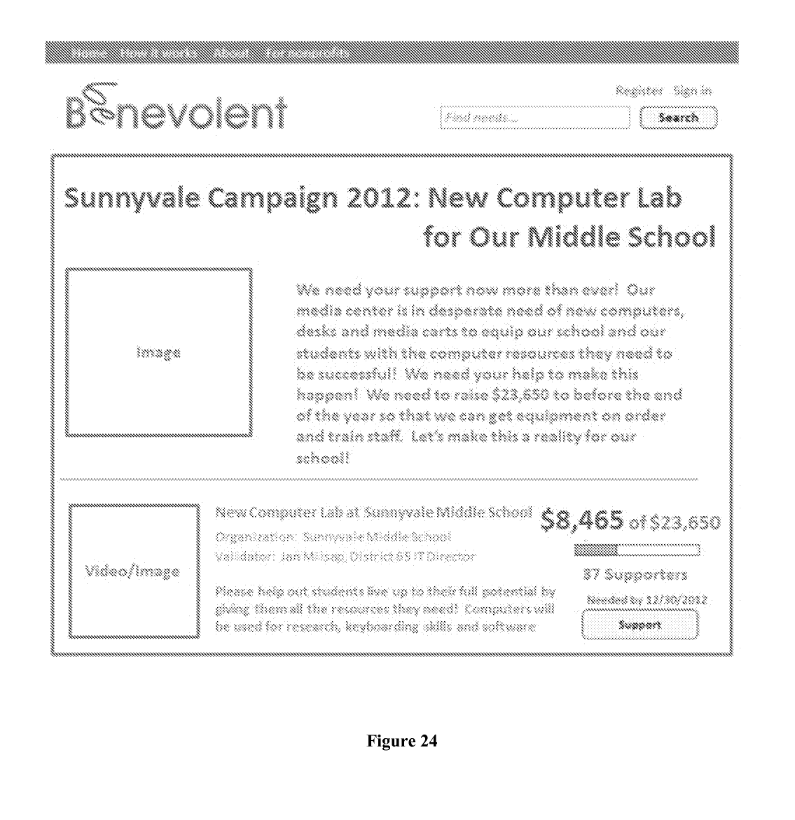

Campaign Home Pages may be managed by the invention and contain an overview of the organization in need of funding and what the need is relevant to (e.g., general operating, youth program support, campaign for a new high school gym, disaster relief, etc.) The Campaign Home Page may also include a brief overview of the need which may have a size limit, the amount of the funds that are needed, images, logos, photos and videos depicting need, expiration date if it's not an ongoing need such as general operating expenses for an organization. This page would also state and determine what happens if a need is not met by the expiration date. There may a narrative section which more fully describes the need. The Local Connector homepage may also contain settings for need metrics, reporting metrics, EIN/SSN or other identity confirmation and payee validation for the Local Connector that will receive the funds and pass them along to the Campaign payee, message setting, etc. An example of a Campaign Homepage can be seen in FIG. 24.

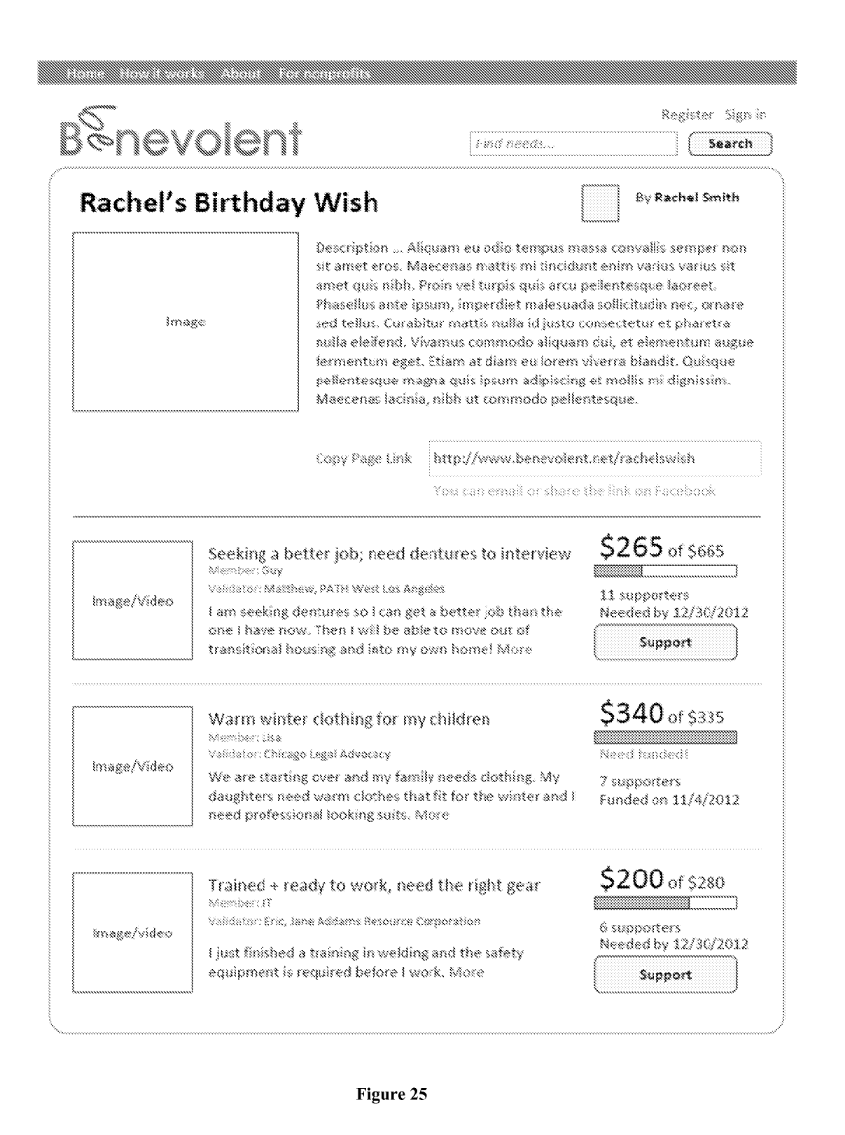

Gift Wish List Pages may be set up by Members who would like to receive donations to needs of their choosing in lieu of some other type of gift. A Member may determine which needs they would like for donors to contribute toward in their honor. The Gift Wish Page may include a narrative section for the Wisher to explain why they chose to handle gifts in this way and why they chose the particular needs they chose. An example of a Gift Wish Page may be seen in FIG. 25.

A key capability of the Gividual platform is creating content that is portable to other websites and media outlets. This may be created using iFrame or other technology that interfaces easily with other online environments. A visual representation of portable content being placed on another organization's site for hyper-local brand integration and linking to the Gividual platform is shown in FIG. 26. An example of portable content being used directly by a media outlet for either publicizing a NEED or linking directly to the Gividual platform is shown in FIG. 27.

LUMZY, or any other program that acts as a mockup and/or prototyping tool for one or more websites or other applications, may be used to create wireframes to create website pages without functionality if desired.

Screen design will be simple, with only critical information on a given screen. The invention and the website using same is about leveling the playing field for the givers and those who need, i.e., the Beneficiaries.

The invention may be accessible through at least one mobile interface using one or more readily available devices. Palm trio may be used to go from anywhere to anywhere in three (3) clicks. Users may not need to get to a product in three (3) clicks but must get into the universe so that they can narrow it down. In an alternative embodiment, one, two or more clicks may be used. The one or more readily available devices may include one or more smart phones, a tablet computer, a laptop computer, a desktop computer, etc.

Activity tracking may be used to monitor who visits what webpages. Such information may be used to see how users navigate through the site (e.g., how a user that is more likely to donate navigates the website), to help people modify information for more successful “hits” or views, to tailor newsfeeds based on browsing history, etc.

Preferably, the user, especially the Beneficiary/Donee, of the website is prevented from writing or deleting his/her own information by accident. This may be implemented for the protection of the users. That said, the Beneficiary/Donee may correct or update information in one or more embodiments. For example, perhaps the Beneficiary's/Donee's contact information or address has changed (if provided at all earlier).

The website may appropriately handle the privacy of information that one or more users enter. For example, when dealing with data storage, it is important to prevent others from getting personally identifiable information (PII). While, preferably, no data is ever removed from the invention, it may be encrypted such that hacking may be eliminated. One mechanism for protecting users, in addition to the initial user agreement, is one or more additional pop up warnings. For example, a pop up warning may appear when people post too many videos, pictures, etc. or files that are too large such that the warning(s) inform those users when they post too much information.

Letting people actually state their own needs and to speak for themselves is breaking new ground in the industry. Indeed, people are willing to tell their story.

Additionally or alternatively, people/donors may donate their time (e.g., independently and/or in addition to money/items) to provide services for any applicable NEED.

While not limited to age, preferably donors and/or donees are at least 18 years of age.

PayPal users don't have to use credit cards for privacy reasons since the website permits use of PayPal. Both may be used alternatively or additionally. Donated money may be transferred by credit card, PayPal, check, etc. A balance sheet may be used to automatically populate the donation information thereon. Additionally or alternatively, other means for transferring payment may be employed, such as creating a trust account with Benevolent.net.

The invention may include prioritizing of one or more needs matches. Criteria which match the most categories may come first, e.g., expiring NEEDS, best match NEEDS, a Rating system for nonprofit validators, etc. Additionally or alternatively, needs may be listed randomly without basis on a priority system. In at least one embodiment, only those non-profit validators who can assure that their clients may thank the donors may be permitted to validate the respective needs of those clients.

The history of the needs that a person has had may be maintained in case the person comes back and has one or more additional needs. Thus, users of the invention may, therefore, know that a user has been in the system in the past and can see that user's history, thereby providing an assurance as to the veracity of the NEED and/or the trust of the user.

Validators may need to be affiliated with a 501(c) organization and have an email address that is associated with the nonprofit to become validators. Additionally or alternatively, an auto-calling feature may be used to reach a validator at the location of the nonprofit to confirm the association of the nonprofit and validator. A ratings system may be used for validators in the event a need is very worthy but the trustworthiness of the actual nonprofit associated therewith is less than ideal. For example, if a validator has a rating above a predetermined threshold, then that validator would not get removed from the system.

For a disaster relief response, a message may be placed on a home page when a disaster strikes. For example, the message may start off by stating “help individuals and families impacted by . . . ” If the users click through, they'll see that it's too soon to know what the one or more needs are. While needs may not have yet been posted, donations may be accepted (with or without the donor's needs preference(s)) and held until the time individuals begin to post needs on the site. Users may allocate the funds personally to individuals who request needs. If the donors don't want to come back on within a predetermined time, the system may automatically allocate it (e.g., based on provided donation preferences). When families list needs, the donors can allocate personally or the invention can do it. The one or more donors may be able to log back in and allocate the donation personally up to a certain date. This may involve a separate validation criteria.

A further example of a NEED from the Beneficiary's perspective (“NEED perspective”) is as follows: Tricia is a 32 year old mom. She has three kids, and she recently found a job with a steady paycheck. She found an apartment for herself and her kids, and she can afford the rent. Tricia has also saved up for the safety deposit, and everything related to renting the apartment. But Tricia has no savings for furniture. She needs beds, a crib, a table and chairs at the very least. Tricia goes to ask her case worker, Lisa, at the nonprofit, which runs the child care center that Tricia's toddler attends, if Lisa has any way to help her get furniture. Lisa looks in the donations at her organization and finds a crib mattress, some sheets and some toys, but nothing more. Lisa sends Tricia away with only those items. After Tricia has gone, Lisa's colleague, Rebecca, tells Lisa about a new website, Benevolent.net. Rebecca isn't certain how it works, but she and Lisa go online and check it out. They browse some of the needs posted and get a sense for how it works. They each register as members and affiliate themselves with their nonprofit organization in the system (see registration sheet examples in FIGS. 21-22) and decide they should encourage Tricia to try it. Two days later, when Lisa next catches up with Tricia, she tells Tricia about Benevolent and asks if Tricia is interested in trying it. Tricia is interested, so Lisa and Tricia sit down in front of a computer together. Tricia registers as a member and adds her need and some personal information. Lisa takes a photo and a short video of Tricia on a cell phone and they follow the directions to upload them to connect to Tricia's need (still logged in as Tricia). When the need is complete, Tricia logs out and Lisa logs in as herself, searches for Lisa and her need, and follows the steps to verify and validate the need, state her nonprofit's willingness to act as the fiscal pass-through for the funds raised, and even uploads a video of herself (Lisa) affirming Lisa and her need from her professional perspective. The need is live in the system.

As a follow-up to the above NEED perspective, an example of the “DONOR perspective” is as follows: Becca comes to Benevolent.net ready to check it out and give money/time/resources. Becca is 42 years old, is married, has three kids, and lives in a suburb of Chicago. She is college educated, active in her kids' schools, and has a strong circle of friends. Becca worked in marketing for a large company until the birth of her second child. She's been home with her children and has a small marketing consulting practice as well. Becca has registered as a member of Benevolent.net and uses the search fields to look for needs that she is interested in like:
Families in her community;
Mothers with cancer (Becca's sister died of cancer two years ago); and
Performing artists (Becca has a background in the theater).

The search returns a listing of active needs in those areas. There are more than fifty (50) NEEDS. Becca clicks on one of the needs—a small preview/summary of the need pops up. Becca decides she's interested in flagging this need so she can go back to it, and clicks on the flag to send it to her short list. Becca closes the preview of that first need and is back looking at the full list. She clicks in and out of about ten (10) more needs, reading the full text on some, watching the videos on almost all, and winds up flagging three in total. She's drawn in by the need statements that are believable, compelling, and where she feels like giving may make a clear difference. She wants to feel connected, and feel like her giving may matter. When Becca revisits the three needs she's flagged for her short list, she eliminates one because she's uncertain about the member in some way. Now Becca has narrowed down to two needs she wants to support today. Becca checks out, deciding on the dollar amount she wants to give to each one. One of the needs is Tricia, the other is Roger, the husband of a victim of cancer who is seeking help in paying for moving costs to relocate himself and his children closer to his parents. With each of the needs she's funding, Becca sees a small prompt asking if she wants to add $10, $15, or more to help support the work of the nonprofit organization helping each of these two members—Tricia and Roger. (Alternatively, Becca may only see the prompt the second time she gives, not the first.) After checkout, Becca may be asked a couple of quick questions to help complete/enhance her profile and experience in the site based on that day's search and giving.

As a follow-up to the above DONOR perspective, an example of the invention learning information, and tailoring the news feed/home page of the user based on that information, is as follows: Once the site has learned more about Becca, when she visits and logs into the site, the newsfeed she sees is reflective of her interests, location, and more. Becca sees needs in her newsfeed related to her interests in her community, mothers with cancer, and artists, but also now shows her needs in the areas of teen moms and families impacted by a recent flood in Missouri based on Becca's recent browsing and giving trends. Becca also sees needs of members affiliated with the nonprofits whose members she's already helped (like other families affiliated with the same child care agency as Tricia). Becca also sees news in her newsfeed telling her what her friends are giving to or following on the Benevolent site (linked to Facebook, LinkedIn, Google+, Twitter, etc.) as well as news about those members who she has given to in the past. There's a posting from Tricia with a photo of her daughter's new bed in the new apartment as well as a photo of Tricia's new kitchen table and chairs. Becca can see that her friend, Christine, who also gave money to help Tricia (after Becca posted to Facebook about Benevolent and Tricia), has commented on Tricia's photos, saying “I hope your daughter loves her new bed and that your family enjoys many happy meals together at the table.” (Christine is sappy like that). Becca's message indicator shows that she's got a message. When she clicks into it, she finds two messages, one from Tricia, thanking Becca and the others who completed the funding for Tricia's furniture need, and another from Lisa who is reporting back on the success of Tricia's need fulfillment and thanking Becca for helping.

Additionally or alternatively, the invention may incorporate one or more of the following actions or features: Employee giving portals, Disaster relief customized applications, Children-specific giving platform, Giving to and from groups, Donor portfolio tools and dashboards, Increased social networking functionality, Facilitation of donation of goods and services targeted to location and individual need, Integration with social networking sites, Customized personalized news feed and interface, Shopping cart, short list and follow features, Geographic-specific portals and/or Customization to the needs of individual nonprofit licensees. The following chart illustrates at least one employee giving portal example:

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

1. A method of allocating one or more charitable donations, comprising:
obtaining at least one charitable need request and information related thereto; and
validating the at least one charitable need request by approving or denying the at least one charitable need request based on at least one of the at least one charitable need request and the related information or by requesting additional information for the at least one charitable need request before approving or denying the request

2. The method of claim 1, wherein at least one of:
(i) the at least one charitable need request is associated with at least one beneficiary or potential beneficiary having the charitable need;
(ii) the related information includes at least one of: information regarding the at least one beneficiary or potential beneficiary; a title of the at least one charitable need request; a short summary of the at least one charitable need request; a longer description of the at least one charitable need request; an email address of the at least one beneficiary or potential beneficiary; a nonprofit name and/or validator name for an entity requested to perform the validating step; a requested deadline for which the at least one charitable need request needs to, or should, be completed; one or more pictures illustrating the at least one beneficiary, the at least one potential beneficiary and/or the need; one or more videos illustrating the at least one beneficiary, the at least one potential beneficiary and/or the need; one or more messages from the at least one beneficiary or potential beneficiary;
(iii) the at least one charitable need request was submitted by, and obtained from, the at least one beneficiary or the at least one potential beneficiary;
(iv) the at least one charitable need request was obtained by at least one of: a processor, a computer, a platform, a database and a website or a server running the website;
(v) a nonprofit entity and/or a local validator performs the validating step;
(vi) the at least one beneficiary and/or the at least one potential beneficiary requests that a particular nonprofit entity or local validator accept the request for validation;
(vii) the nonprofit entity and/or the local validator accepts or denies the opportunity to validate the at least one charitable need request;
(viii) the nonprofit entity and/or the local validator has personal knowledge of at least one of the at least one beneficiary or the at least one potential beneficiary and the at least one charitable need request;
(ix) the validating step permits one or more donors to trust the at least one charitable need request; and
(x) the validating step further comprises validating the at least one beneficiary or the at least one potential beneficiary associated with the at least one charitable need request such that the one or more donors may further trust the at least one charitable need request.

3. The method of claim 2, wherein the at least one of the website, the platform, the server running the website, the database, the processor, and the computer are controlled or operated or substantially controlled or substantially operated by a third party entity acting as a middle entity between the at least one beneficiary or the at least one potential beneficiary and one or more donors fulfilling, and/or looking to fulfill, the at least one charitable need request.

4. The method of claim 3, wherein:
the third party entity creates and/or manages one or more user accounts for at least one of: the at least one beneficiary or potential beneficiary; the one or more donors; and the nonprofit entity and/or local validator; and
the one or more user accounts operate to provide access to the at least one of the website, the platform, the server running the website, the database, the processor, and the computer.

5. The method of claim 2, further comprising authenticating the nonprofit entity and/or the local validator using information related to the nonprofit entity and/or the local validator to perform a background check on the nonprofit entity and/or the local validator, thereby improving security for at least one of the at least one charitable need request, the at least one beneficiary, the at least one potential beneficiary, and the nonprofit entity and/or the local validator such that the one or more donors trust, and donate to, the at least one charitable need request.

6. The method of claim 5, wherein at least one of:
(i) a local connector associated with the nonprofit entity and/or the local validator performs the authenticating step of the nonprofit entity and/or the local validator; and
(ii) the information related to the nonprofit entity and/or the local validator includes at least one of: a history of approval rating for prior one or more validations; an association of the nonprofit entity and/or the local validator with one or more local connectors; an association of the nonprofit entity and/or the local validator with the local connector; an association of the nonprofit entity and/or the local validator with an organization having an account or profile stored with at least one of the website, the platform, the server running the website, the database, the processor, and the computer; and whether the at least one beneficiary or potential beneficiary requested the nonprofit entity and/or the local validator to validate the at least one charitable need request.

7. The method of claim 6, further comprising:
applying to be a local connector;
providing the local connector application to a third party entity acting as a middle entity between the at least one beneficiary or the at least one potential beneficiary and the one or more donors;
authenticating the local connector by having the third party entity perform a background check on the local authenticator; and
approving or denying the local connector application, wherein the local connector application is approved or denied by the third party entity.

8. The method of claim 5, further comprising providing access to the at least one charitable need request to the one or more donors via at least one of the website, the platform, the server running the website, the database, the processor, and the computer, when the request is approved; and denying access to the at least one charitable need request via the at least one of the website, the platform, the server running the website, the database, the processor, and the computer when the request is denied.

9. The method of claim 8, wherein the providing access step further comprises at least one of:
displaying at least one of a profile of the at least one beneficiary or the at least one potential beneficiary, a description of the at least one charitable need request, a notice indicating that the at least one charitable need request was validated, a notice indicating that the nonprofit entity and/or the local validator was authenticated, one or more pictures of the at least one beneficiary or the at least one potential beneficiary, one or more pictures illustrating the requested need and one or more videos of the at least one beneficiary or the at least one potential beneficiary explaining the requested need;
permitting the one or more donors to communicate directly with the at least one beneficiary or the at least one potential beneficiary;
displaying a list of a plurality of the at least one charitable need requests based on one or more preferences provided by the one or more donors; and
displaying a list of a plurality of the at least one charitable need requests based on one or more categories, wherein the categories include at least one of: education, employment, healthcare, household, housing, technology and transportation.

10. The method of claim 8, wherein at least one of:
(i) the at least one approved charitable need request comprises a plurality of approved charitable need requests such that the one or more donors are able to donate one or more funds, volunteer time and/or item(s) to each of the plurality of approved charitable need requests; the distribution of the one or more funds, volunteer time and/or item(s) being selected by the one or more donors and/or being selected based on one or more preferences or designations of the one or more donors;
(ii) the at least one approved charitable need request comprises a plurality of approved charitable need requests such that the one or more donors are able to donate one or more funds, volunteer time and/or item(s) equally to each of the plurality of approved charitable need requests;
(iii) the one or more funds, volunteer time and/or item(s) are allocated amongst the plurality of approved charitable need requests based on one or more preferences or designations provided by the one or more donors;
(iv) the at least one beneficiary or potential beneficiary receiving the one or more funds, volunteer time and/or item(s) comprises at least one of: a selected or predetermined individual, a selected or predetermined group and a selected or predetermined nonprofit entity;
(v) the one or more donors comprise one donor and the at least one beneficiary or potential beneficiary comprises one beneficiary or potential beneficiary;
(vi) the one or more donors comprise a plurality of donors and the at least one beneficiary or potential beneficiary comprises a plurality of beneficiaries or potential beneficiaries;
(vii) the at least one beneficiary or potential beneficiary comprises one beneficiary or potential beneficiary;
(viii) the one or more donors comprise one donor; and
(ix) the at least one of the website, the platform, the server running the website, the database, the processor, and the computer are controlled or operated or substantially controlled or substantially operated by a third party entity acting as a middle entity between the at least one beneficiary or the at least one potential beneficiary and the one or more donors fulfilling the at least one charitable need request.

11. The method of claim 10, wherein:
the third party entity creates and/or manages one or more user accounts for at least one of: the at least one beneficiary or potential beneficiary; the one or more donors; the nonprofit entity and/or the local validator; and the local connector; and
the one or more user accounts operate to provide access to the at least one of the website, the platform, the server running the website, the database, the processor, and the computer.

12. The method of claim 8, further comprising searching for the at least one charitable need request based on one or more search criteria, wherein the one or more search criteria include at least one of: geographical region(s), demographic region(s), household situation of the at least one beneficiary or the at least one potential beneficiary, need amount, date the at least one charitable need request was created, deadline of the at least one charitable need request, one or more preferences of the one or more donors, and a number of donors presently supporting the at least one charitable need request.

13. The method of claim 8, further comprising at least one of:
(i) receiving one or more funds, volunteer time and/or item(s) from the one or more donors;
(ii) checking to see if a predetermined minimum threshold for the at least one charitable need request has been met and, once the threshold has been met, transferring the one or more funds, volunteer time and/or item(s) to at least one of the validating nonprofit entity, the local validator and the authenticating local connector to handle distribution and/or reporting of the one or more funds, volunteer time and/or item(s) to the at least one beneficiary or potential beneficiary of each of the at least one charitable need request;
(iii) transferring the one or more funds, volunteer time and/or item(s) to at least one of the validating nonprofit entity, the local validator and the authenticating local connector to handle distribution and/or reporting of the one or more funds, volunteer time and/or item(s) to the at least one beneficiary or potential beneficiary of each of the at least one charitable need request;
(iv) identifying each of the at least one charitable need request that the one or more donors identify with and/or want to donate to before receiving the one or more funds, volunteer time and/or item(s), thereby establishing a personal connection between the one or more donors and the at least one beneficiary or the at least one potential beneficiary;
(v) identifying each of the at least one charitable need request that the one or more donors identify with and/or want to donate to, after receiving the one or more funds, volunteer time and/or item(s), based on one or more preferences provided by the one or more donors, thereby establishing a personal connection between the one or more donors and the at least one beneficiary or the at least one potential beneficiary;
(vi) changing or updating the status of the at least one charitable need request as being met or unmet;
(vii) changing or updating the outstanding requested amount of fund(s) and/or item(s) of the charitable need request based on the amount of the received one or more funds, volunteer time and/or item(s);
(viii) adding one or more overhead costs to the requested amount such that the total amount requested from the one or more donors includes additional funds for covering and handling the transfer from the one or more donors through the at least one of the website, the platform, the server running the website, the database, the processor, and the computer to the nonprofit entity or local validator, the local connector and finally to the at least one beneficiary or potential beneficiary;
(ix) providing an option for the one or more donors to share the donation through one or more social media of the one or more donors or through email from the one or more donors;
(x) displaying portable content on another organization's media outlet and/or website for hyper-local brand integration and linking to the at least one of the website, the platform, the server running the website, the database, the processor, and the computer;
(xi) populating a database record, the record being associated with the at least one charitable need request with the information provided through the at least one of the website, the platform, the server running the website, the database, the processor, and the computer; and
(xii) checking to see if a predetermined minimum threshold for the at least one charitable need request has been met and, if the threshold has not been met, returning the one or more funds, volunteer time and/or item(s) to the one or more donors.

14. The method of claim 13, further comprising receiving feedback from the at least one beneficiary or the at least one potential beneficiary explaining how the one or more funds, volunteer time and/or item(s) have helped the need of the at least one beneficiary.

15. The method of claim 13, wherein the receiving the one or more funds, volunteer time and/or item(s) step further comprises at least one of:
receiving one or more funds from the one or more donors through at least one of: a credit card transaction; a PayPal account transaction; a bank wire transfer; a payroll deduction of the one or more donors; an employee matching fund for an employer of the one or more donors; and
an employee giving portal and interface according to one or more preferences of the employer of the one or more donors; and
receiving a name of a predetermined person that is not the one or more donors such that the one or more funds, volunteer time and/or item(s) are given or made in the name of the predetermined person instead of the one or more donors as a tribute gift or donation.

16. The method of claim 15, further comprising at least one of:
creating a secure account on the at least one of the website, the platform, the server running the website, the database, the processor, and the computer; and
storing credit card information on the secure account such that the credit card information does not need to be re-entered every time the credit card transaction or a credit card transaction Occurs.

17. The method of claim 16, further comprising at least one of:
logging into a social media account in order to create the secure account on the at least one of the website, the platform, the server running the website, the database, the processor, and the computer;
creating a password for the secure account;
entering, receiving or obtaining user information and associating the user information with the respective secure account; and
cross-checking the user information with other user information already entered into the at least one of the website, the platform, the server running the website, the database, the processor, and the computer to confirm that there is only one user account per member of the at least one of the website, the platform, the server running the website, the database, the processor, and the computer.

18. The method of claim 13, wherein at least one of:
(i) the one or more donors comprise one donor and the at least one beneficiary or potential beneficiary comprises one beneficiary or potential beneficiary;
(ii) the at least one beneficiary or potential beneficiary comprises one beneficiary or potential beneficiary;
(iii) the one or more donors comprise one donor; and
(iv) the one or more donors comprise a plurality of donors and the at least one beneficiary or potential beneficiary comprises a plurality of beneficiaries or potential beneficiaries.

19. The method of claim 13, further comprising forming one or more need communities on the at least one of the website, the platform, the server running the website, the database, the processor, and the computer, wherein at least one of the at least one beneficiary or potential beneficiary; the one or more donors; the nonprofit entity and/or the local validator; the local connector; the third party entity and any other member of the one or more need communities interact with each other within the one or more need communities.

20. A non-transitory computer-readable storage medium containing software code operating to cause one or more of a plurality of processors to perform the steps, comprising:
obtaining at least one charitable need request and information related thereto; and
validating the at least one charitable need request by approving or denying the at least one charitable need request based on at least one of the at least one charitable need request and the related information or by requesting additional information for the at least one charitable need request before approving or denying the request.
